(19) United States
(12) Patent Application Publication
(10) Pub. No.: US 2024/0054482 A1
(43) Pub. Date: Feb. 15, 2024

(54) SECURE WEB-BASED PLATFORM FOR DE-CENTRALIZED FINANCING

(71) Applicant: SATSCHEL INC., Las Vegas, NV (US)

(72) Inventors: Jayant Dwarkanath Sonsurkar, Cranbury, NJ (US); Shubham Shukla, Allahabad (IN); Abhishek Mahra, Las Vegas, NV (US)

(21) Appl. No.: 18/234,283

(22) Filed: Aug. 15, 2023

Related U.S. Application Data
(60) Provisional application No. 63/398,144, filed on Aug. 15, 2022.

(51) Int. Cl. G06Q 20/36; G06Q 20/40; G06Q 20/38

(52) U.S. Cl. CPC G06Q 20/3674; G06Q 20/4014; G06Q 20/389

(57) ABSTRACT

In accordance with embodiments, a decentralized financing system provides secure encrypted key retrieval by storing a user's encrypted private key on a Cloud keychain, accessible using the user's smart device, such as an iPhone or an Android device. To log on to her account, the user undergoes AML-KYC compliance, as well as liveness tests. In some embodiments, for quick retrieval and added security, the system stores the KYC-AML reference IDs but does not store any personal identifying information. The system further allows for minting an asset, such that AML-KYC compliance data, as well as other data of interest to regulators and traders alike, are publicly viewable absent personal identifiable information. Further, the system allows for asset creators and other selected parties to receive royalties for downstream trades of the asset.

### RELATED APPLICATION(S)

This application claims priority under 35 U.S.C. § 119(e) of the co-pending U.S. Provisional Patent Application Ser. No. 63/398,144, filed Aug. 15, 2022, and titled “SECURE WEB-BASED PLATFORM FOR DE-CENTRALIZED FINANCING,” which is hereby incorporated by reference in its entirety.

### FIELD OF THE INVENTION

This invention is directed to decentralized transactions. More specifically, this invention is directed to bridging traditional financing with decentralized financing by providing for any one or more of key retrieval, compliance, token minting, and downstream royalty generation.

### BACKGROUND

Decentralized (blockchain) Financing (“DeFi”) networks have many advantages over their traditional centralized counterpart: Among other things, they do not rely on a centralized system, which can be prone to attack and delayed processing. They provide permanent, immutable transaction records. They allow greater user flexibility in what information to include in blockchains.

DeFi networks also have limitations. For example, to set up a wallet in a DeFi account, the finance authority provides a user with a multi-word seed phrase and a private key. If the user loses either the seed phrase or the private key, or her smart device storing either one, she is locked out of her account and any assets in the wallet are irretrievable.

Second, compliance checks, such as Anti Money Laundering (“AML”) and Know Your Client (“KYC”), are expensive, time consuming, and difficult to implement. As a result, they use an inordinate amount of computer resources.

Third, information about assets issued on DeFi networks are not transparent. Regulators and users cannot easily verify compliance or determine other information relevant to their decision to purchase an asset. This may slow the trading of assets, while regulators and other interested parties determine the authenticity of the asset or its creator.

Finally, the asset creator cannot control downstream sales of the asset, such as on secondary markets. The tokens contain no triggering mechanism for providing the owner with royalties beyond the first sale.

There is a need for solving one or more of these drawbacks.

### SUMMARY OF THE INVENTION

Embodiments of the invention solve any one or more of the above problems. As for key recovery, the system advantageously allows for remote, secure private key retrieval by associating the user's account (e.g., smart device identifier, such as an AppleID or AndroidID) with the private key on a remote iCloud keychain. Thus, even if the user loses her phone or otherwise cannot access her private key, she can use her iPhone® to retrieve the private key over the iCloud keychain. That is, she can restore her iPhone by retrieving her encrypted private key on the iCloud keychain, so long as she can log on to her iCloud account. In some embodiments, the private key is securely stored on a keychain on an Apple secure enclave.

Other embodiments provide additional security by also associating AML-KYC testing to the AppleID or Android ID in a security enclave (for Apple devices) or similar structure for Android, Google, or other devices. Still other embodiments apply these techniques in minting assets, making all details of the asset issuance transparent, and generating downstream royalties for the asset creator and, optionally, other selected parties.

In a first aspect, in a decentralized financing system, a computer-implemented method includes receiving on a smart device a login request from a user for accessing a digital wallet; verifying an identity of the user on the smart device using a verification sequence; after verifying the user's identity, retrieving the user's encrypted private key over a cloud network; and using the retrieved encrypted private key to log on to the user's wallet from the smart device.

In some embodiments, the user's encrypted private key is stored on an iCloud keychain accessible over an iCloud network. In some embodiments, the user's encrypted private key is indexed by associating the user's account with the iCloud keychain. In some embodiments, the user's account is associated with the user's account ID. In some embodiments, the account ID includes an AppleID or an AndroidID.

In some embodiments, the verification sequence is based on plain text data, Zero-Knowledge Proofs, or both. In some embodiments, the Zero-Knowledge Proofs are based on one or more of KYC ID, PEPs ID, Sanctions ID, AGE ID, Transaction Monitoring ID, and Accreditation ID. In some embodiments, the plain text data includes one or more of a KYC date/time stamp, KYC Rigor, a PEPs date/time stamp, a Sanctions date/time stamp, an Accreditation date/time stamp, a Country in which a transaction associated with verification sequence occurs, and a State in which the transaction associated with verification sequence occurs. In some embodiments, the verification sequence includes Anti-Money Laundering (AML), Know Your Client (KYC), Know Your Business, any other types of legal compliance requirements, or any combination thereof. In some embodiments, the verification sequence further includes one or more biometric similarity tests, one or more liveness tests, or any combination thereof. In some embodiments, the method further includes storing in a database or storing encrypted on-chain results of the user's AML and KYC compliance check, indexed by an AML-KYC reference ID, without storing the user's personal identifying information. In some embodiments, the method further includes executing a financial transaction on a private blockchain, wherein each of the nodes of the private blockchain is associated with a bank, and transactions on the nodes are not publicly viewable.

In a second aspect, in a decentralized financing system, a computer-implemented method for minting an asset includes verifying an identity of a user, using any combination of AML, KYC, and KYB; storing information relating to the verification of the user, indexed by a reference ID and timestamp; entering token creation and minting data into a token creation and minting form; encrypting the token creation and minting data; storing the encrypted token creation and minting data and asset metadata, wherein the asset metadata includes a symbol name, an image, and a royalties schedule; updating a token to include token creation and minting data using a smart contract; triggering a blockchain transaction; for every blockchain transaction, replicating token and minting data into a database, and adding onboarding information, excluding personal identifying information, into a memo field; and in response to a successful transaction, minting the asset on the blockchain.

In some embodiments, the method further includes transmitting royalty payments to one or more designated parties for each downstream transaction for the asset according to the royalties schedule. In some embodiments, the token creation and onboarding information are publicly viewable on the blockchain and one or more exchanges.

In a third aspect, in a decentralized financing system, a computer-implemented method includes receiving on a smart device a login request from a user for accessing a digital wallet; verifying an identity of the user on the smart device using a verification sequence; after verifying the user's identity, retrieving the user's encrypted private key over a cloud network; and using the retrieved encrypted private key to log on to the user's wallet from the smart device, wherein the user's wallet is accessible by unidirectional diodes with non-overlapping access windows. In one embodiment, the digital wallet includes an HSM Trusted client coupled to an on-premises HSM storing the user's private key, wherein the HSM Trusted client is communicatively coupled to the on-premises HSM at pre-determined windows.

### BRIEF DESCRIPTION OF THE FIGURES

Further advantages of the present disclosure will become apparent by reference to the detailed description of preferred embodiments when considered in conjunction with the drawings, which are provided as illustration, not limitation, of the invention. In the figures, the same label refers to the same or similar element.

FIG. 1 illustrates a high level diagram of the components of a system for a secure login to a decentralized finance network, in accordance with some embodiments of the invention.

FIGS. 2A and 2B show the steps of processes for securely logging into the system of FIG. 1 by accessing a private key from an iCloud keychain, in accordance with some embodiments of the invention.

FIG. 3 is a block diagram of a data block for associating an AppleID with a private key, stored on an iCloud keychain, in accordance with some embodiments of the invention.

FIG. 4 illustrates components of a system for verifying an identity of a customer using AML-KYC, in accordance with some embodiments of the invention.

FIG. 5 shows the steps of a process for verifying an identity of a customer using the system of FIG. 4, in accordance with some embodiments of the invention.

FIG. 6 illustrates the components of a system for asset minting, in accordance with some embodiments of the invention.

FIG. 7 illustrates the steps of a process for minting an asset using the system of FIG. 6, in accordance with some embodiments of the invention.

FIG. 8 shows KYC-AML verification information, a component of Onboarding Information, in accordance with some embodiments of the invention.

FIG. 9 is a block diagram showing the fields of a token, in accordance with some embodiments of the invention.

FIG. 10 illustrates a chain in blockchain recording transactions for an asset traded on an exchange, in accordance with some embodiments of the invention.

FIG. 11 illustrates a Web-based platform for trading an asset on a public securities exchange, making a transaction on a private banking blockchain, or both in accordance with some embodiments of the invention.

FIG. 12 is a high-level diagram of a system for securely creating and storing private keys for signing transaction data for transmission over a blockchain network in accordance with some embodiments of the invention.

FIGS. 13A-B show windows (pulse trains) for transmitting or processing data such as transaction data and key tags in accordance with some embodiments of the invention.

FIGS. 14A-C are block diagrams of window generators in accordance with some embodiments of the invention.

FIG. 15 shows the lifecycle of a signing key inside an HSM in accordance with some embodiments of the invention.

FIG. 16 shows the steps of a method of transmitting transaction data and key tags and signing the transaction data, all in accordance with some embodiments of the invention.

FIG. 17 is a high-level diagram of a firewall system for securely creating, storing, and using private keys for signing transactions in a network in accordance with some embodiments of the invention.

FIGS. 18A-B are block diagrams of one-way air-gapped communication channels in accordance with some embodiments of the invention.

FIG. 19 is a block diagram and flow of using a quorum authorization scheme (“multisig”) to access keys stored in hardware security modules (HSMs) in accordance with some embodiments of the invention.

FIG. 20 shows the steps of a process for verifying a transaction using a secure enclave in accordance with some embodiments.

FIG. 21 is a block diagram of a system for securing digital wallets in accordance with some embodiments.

### DETAILED DESCRIPTION

Embodiments of the invention provide increased system security and robustness in DeFi and other blockchain networks. Among other advantages, the embodiments allow a user to securely retrieve her private key over an iCloud keychain by associating her AppleID with her private key. In accordance with other embodiments, the system also associates the user's AppleID with AML-KYC validation, for subsequent transactions after initiation. This strategy reduces the computer processing and memory that would otherwise be required for performing AML-KYC validation for later transactions and, either alone or in combination with the iCloud keychain storage, provides increased security.

In other embodiments, in a DeFi network for minting assets, the invention provides transparency for regulators and other third parties. When the asset is issued, files are embedded in the token, including details of the registration, allowing anyone to view them. This information includes, for example, AML-KYC validation data, such as the tests performed and the validating authority.

Some embodiments provide for the generation of downstream royalties for the asset creator and optionally other parties, allowing them to benefit from downstream trades of the asset, such as one secondary markets. Still other embodiments include all or a subset of these features.

The following detailed description is presented to enable a person skilled in the art to make and use the systems and methods of the present disclosure. For purposes of explanation, specific details are set forth to provide an understanding of the present disclosure. However, it will be apparent to one skilled in the art that these specific details are not required to practice the embodiments of the present disclosure. The present disclosure is not intended to be limited to the embodiments shown but is to be accorded the widest possible scope consistent with the principles and features disclosed herein.

### Storing Private Keys on Remote Cloud-Based Keychains

In accordance with some embodiments, after users create their DeFi account, their private key is stored in the iCloud keychain, which makes it easy to access their key even if they lose or otherwise cannot access their private key. Because of iCloud's closed ecosystem, the Platform achieves additional security by storing the private key, in the keychain, while not storing any personal identifiable information (“PII”) on the iPhone or on the public block chain. As still an additional layer of security, the user uses a biometric and public key to login to their Wallet mobile app on the iPhone. It will be appreciated that while many of the examples herein refer to an iPhone, other devices can also be used in accordance with the embodiments, including an Android device, a different user platform, or any device on the public blockchain, to name only a few examples.

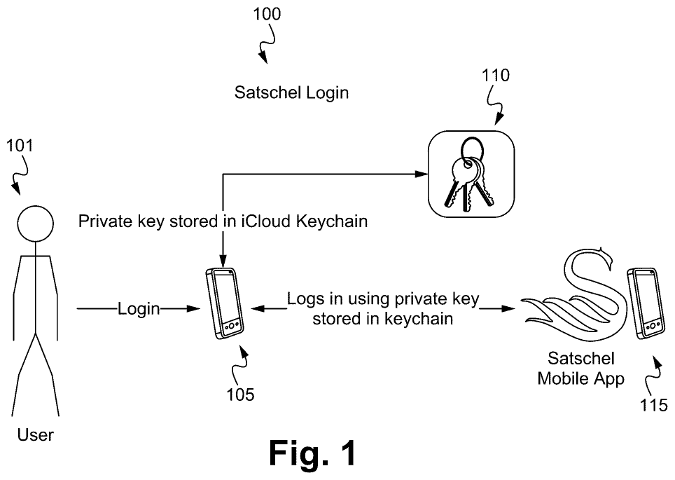

FIG. 1 is a high-level diagram of a system 100 for a user 101 to securely access her wallet, in accordance with some embodiments. The system 100 includes an iPhone® 105 coupled to an iCloud Keychain 110 over the iCloud® and to a mobile application 115 over a network.

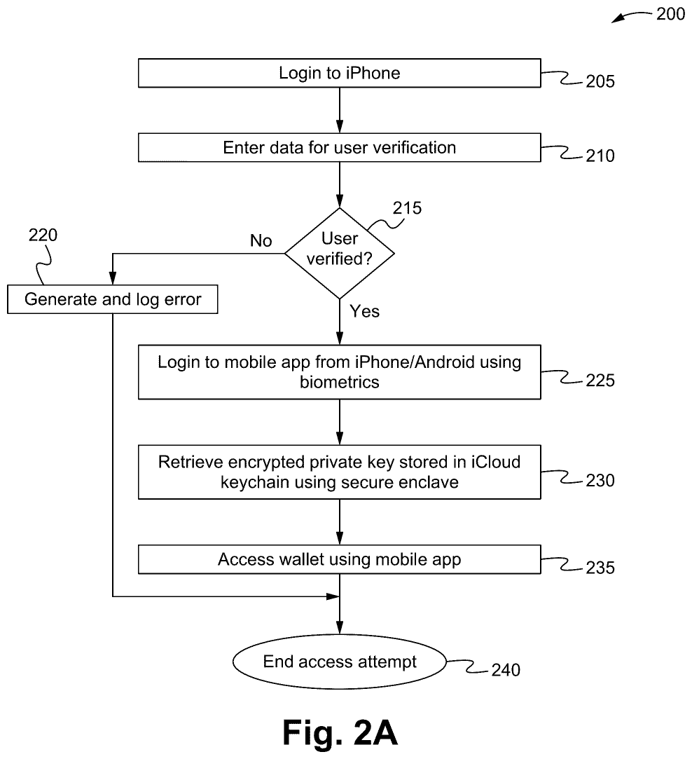

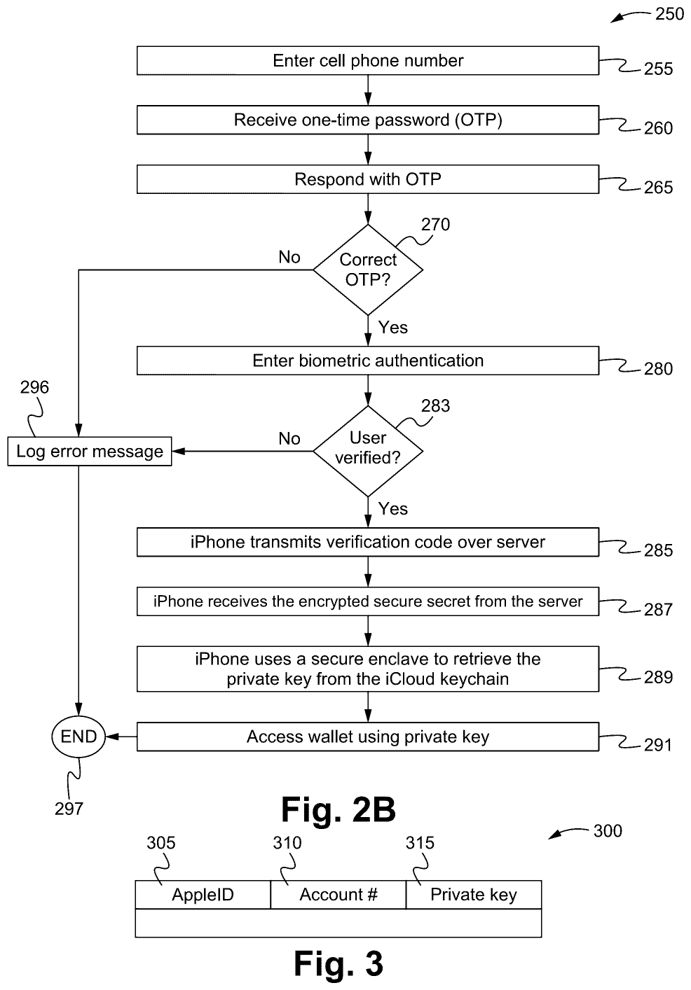

FIG. 2A shows steps 200 of a process for logging into a user account using the system 100, in accordance with some embodiments. As explained in more detail below, the user 101 first verifies her identity on the iPhone 105, which later retrieves and uses her private key to make transactions to and from her wallet over a DeFi network.

As part of the initial account set-up (not shown), the user 101 selects a secret recovery phrase. In some embodiments, the recovery phrase is a 12-word phrase, though 18-word, 24-word phrases, or phrases of other lengths, can also be used. The 12-word phrase is converted into a seed integer which, when used with a standard derivation algorithm, is used to derive the user's master private key.

Next, in the set-up process, the system 100 associates the user's AppleID with her account and thus with her private key. In some embodiments, shown in FIG. 3, the keychain includes storage containing a user entry 300 associating the user's AppleID 305 with her account number 310 and private key 315. In some embodiments, the entry 300 is stored in an Apple keychain contained in an Apple enclave accessible over the iCloud. In some embodiments, the Apple enclave includes computer-executable instructions for encrypting key and other data using an enclave key, a processor for executing the instructions, and an enclave key for encrypting data in the enclave. This remote storage of the user's private key allows secure storage and retrieval of the private key, even if the user forgets her seed phrase, password, or other recovery data.

Referring again to FIG. 2A, after initiation, in a step 205 the user uses her iPhone® 105 to log into her Apple account using, for example, an iPhone password, pass phrase, or personal identification number, or any combination of these. Next, in a step 210, the user enters personal identifying information, such as biometric information, to verify her identity on the iPhone 105. In a step 215, the system 100 determines whether the user is verified using the identifying information. If the user's identity is verified in the step 215, the process continues to a step 225. Otherwise, the process continues to a step 220, in which the system generates and logs an error message and then continues to the step 240, where the process ends without allowing the user to log into her Apple account.

In the step 225, the user logs on to the mobile application 115 from the iPhone/Android device using biometrics. Next, in a step 230, the iPhone 105 retrieves the encrypted private key stored in the iCloud keychain 110 using the secure enclave. In a step, 235, the mobile application 115 uses the encrypted private key to access the wallet to transfer funds. Next, the process continues to the step 240, where it ends.

FIG. 2B shows the steps 250 of a process for accessing a user's wallet in accordance with another embodiment of the invention. In a step 255, the user provides her cell phone number at a login portal on her iPhone 105. Next, in a step 260, the system sends a one-time passcode (“OTP) to the iPhone 105. Next, in a step 265, the user responds on her iPhone 105 with the OTP, thereby verifying that the OTP was sent to the correct destination. In a step 270, the system determines whether it received the correct OTP. If the correct OTP was not sent, the process continues to a step 296, where the system logs an error message, and then proceeds to a step 297, where the process ends, without allowing the user to access her private key.

If, in the step 270, it is determined that the user provided the correct OTP, the process continues to a step 280, where the iPhone 105 prompts the user for and receives her biometric information, such as from a camera that captures facial images, a fingerprint scanner, an iris scanner, or any other biometric device or combination of biometric devices that the iPhone or other device supports.

Next, in a step 283, the iPhone 105 uses the biometric information to determine whether the user's identity is verified. If, in the step 283, it is determined that the user's identity is not verified, the process continues to the step 296. Otherwise, the process continues to a step 285, where the iPhone transmits a “verification” code over the server, and then proceeds to a step 287, where the iPhone receives the encrypted secure secret from the server. Next, in a step 289, the iPhone 105 uses the secure enclave to retrieve the private key from the iCloud keychain. In a step 291, the iPhone transmits the private key to the mobile application 115 to access the user's wallet. From the step 291, the process continues to the step 297, where the logon sequence ends.

While the example above describes using an Apple keychain, it will be appreciated that the principles of the invention can be used with other smart devices, such as Google smart phones and Android devices, to name only a few examples.

### AML and KYC

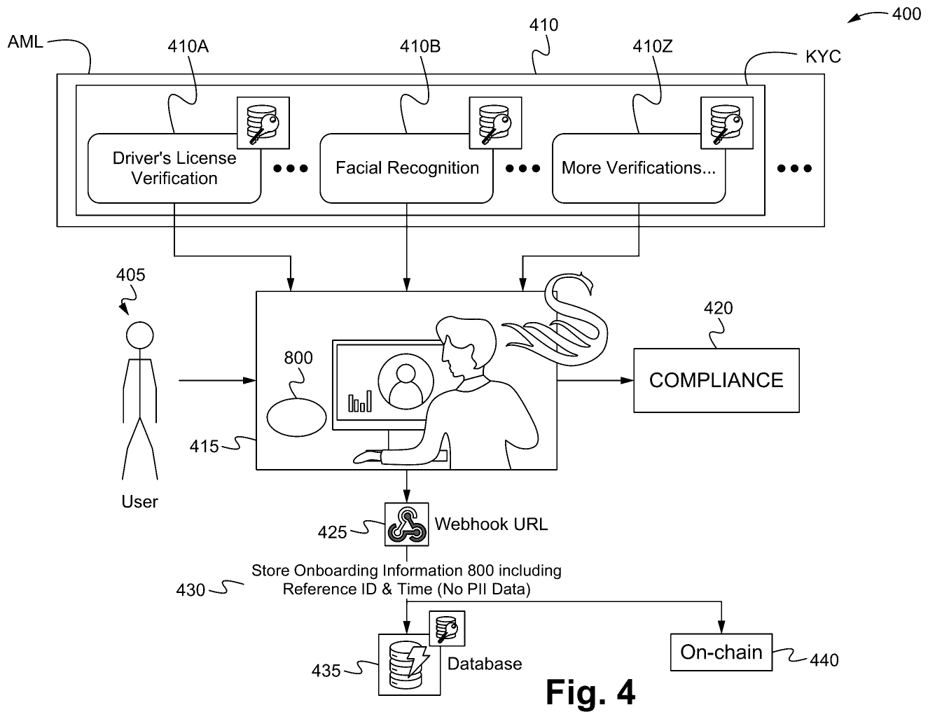

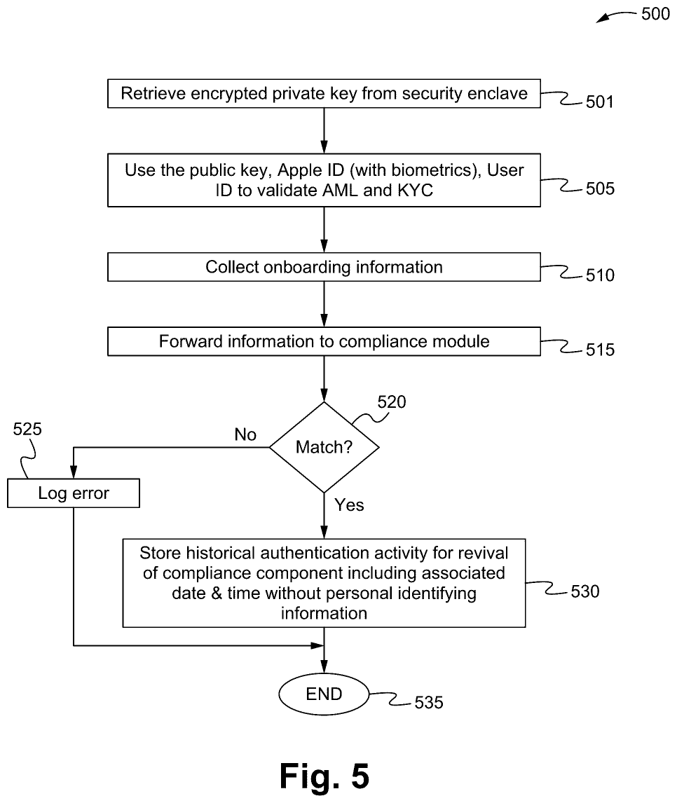

In some embodiments, on the first login to the system 100, a user is authenticated using the sub-system 400 illustrated in FIG. 4, in accordance with the steps of the process 500 in FIG. 5. The sub-system 400 includes a User Interface 415 accessible to a user 405 and coupled to a Know Your Client (KYC) Module 410, a Compliance Module 420, a Database 435, and an On-chain Module 440. The User Interface 415 is coupled to the Database 435 and the On-chain Module 440 through a Webhook URL 425.

The KYC Module 410 and Compliance Module 420 ensure that a customer is who she says she is. The KYC Module 410 includes a Driver's License Verification Module 410A, a Facial Recognition Module 410B, and optional additional verifications module 410Z, using documents such as government-issued passports or customized identifications. In some embodiments, each of the Modules 410A, 410B, and 410Z contains verification data.

In an initialization sequence (not shown), a user's authentic (verified) identification information is stored. For example, either a user or a trusted authority enters information from the user's driver's license, later stored on the Driver's License Module 410A, including, for example, the user's name, driver's license number, address, and date of birth. Similarly, digital photographs of the user from front, quarter profile, and side profile are entered and stored in the Facial Recognition Module 410B. Optionally, other personal identification information can be entered and stored in the More Verifications Module 410Z, such as biometric data including fingerprint, retinal data, or both.

Referring to FIGS. 4 and 5, in operation, during a first log in, in a step 501, the system retrieves an encrypted private key from the security enclave. Next, in a step 505, the system uses the corresponding public key, Apple ID (with biometrics), and User ID to validate AML and KYC. Next, in a step 510, the user enters and the system collects onboarding information 800 (defined below), including AML-KYC data, such as by entering her driver's license information and, depending on what the Interface 415 prompts for, undergoing a facial scan and an optional fingerprint scan. In different embodiments, the Interface 415 includes a keyboard and a biometric scanner, such as camera, a fingerprint scanner, or a retinal scanner, to name only a few examples.

Next, in a step 515, the Interface 415 forwards the original (verified) AML-KYC data from the AML-KYC Module 410 and any other collected onboarding information, collected at the Interface 415, and sends both sets of data to the Compliance Module 420. In a step 520, the Compliance Module 420 compares the relevant original and collected onboarding information. If the two sets do not match within a predetermined threshold, the process continues to a step 525, in which an error is logged, and then continues to a step 535, where the process ends. Otherwise, if the two sets do match within the predetermined threshold, the process continues to a step 530, in which historical authentication activity for revival of the Compliance component are stored in the database 435 and on-chain 440, through the Webhook URL 425, including onboarding information 800, including the Refence ID and Date and Time. In one embodiment, personal identifying information (PII) is not stored in the database 435 or on-chain 440. In other embodiments, PII is stored in the database 435, on-chain 440, or both. From the step 535, the process continues to the step 535.

In some embodiments, in the step 520, only selected elements of the onboarding information are compared.

In some embodiments, the database 435 ties the AML-KYC Compliance data to the AppledID (or AndroidID) by a security enclave. In some embodiments, the database 435 comprises a key-value database, such as an SQLite database, or a secure enclave that associates the AML-KYC to the AppledID (or AndroidID). After reading this disclosure, those skilled in the art will recognize other databases that can be used in accordance with the embodiments.

In some embodiments, the step 520 also includes one or more liveness tests, to prevent spoofing. As one example, a liveness test is performed using a camera. The user is prompted to face the camera at predetermined facial angles and positions (e.g., front profile, quarter profile, and full profile views). The captured images are then compared to expected ones. If the two sets match, the liveness test is passed. As another example, the system includes a fingerprint scanner, and the liveness test checks for blood flow, active pores, skin whitening (e.g., indicating pressure of a real finger on a sensor surface), and the presence of veins, to name only a few possible characteristics. Those skilled in the art will recognize other possible liveness tests in accordance with the embodiments. If the liveness test is failed—such as by detecting unnatural or unexpected facial movements—the system will continue to the step 525, and to the step 535, where the process ends.

It will be appreciated that FIGS. 4 and 5 are merely illustrative. Various modifications can be made within the spirit of the invention. For example, the AML-KYC Module 410 can collect more or fewer sets of information from the Interface 415 and used by the Compliance Module 420 to verify the identity of a user. As one example, the collected AML-KYC information includes only the user's first name, last name, and date of birth.

It will be appreciated that while the examples herein describe AML-KYC Compliance, the embodiments contemplate other legally required compliance verification and corresponding data.

### Minting an Asset

In accordance with the principles of some embodiments, after it is determined that a user is compliant, such as illustrated in FIGS. 4-5, the user is able to mint an asset. In some embodiments, an asset is minted using a Smart Contract in a blockchain that records the transactions related to the asset. In some embodiments, the Smart Contract is a Ricardian contract. In some embodiments, before minting the asset, the user provides information about the asset, such as the asset's name, trading symbol, token supply, image, files, whitelisting, royalties, multisig, registration, private placement memorandum (PPM), and other relevant legal documents, to name only a few items of information. In this way, regulators can see, among other things, at the transaction level, who did the compliance check, where the compliance check was performed, any transactions to and from wallets, the locations (e.g., country) where the transactions were initiated. etc. In some embodiments, no PII is stored or publicly viewable. The abstraction of a user ID is viewable. In this way, the Smart Contract provides transparency into each transaction.

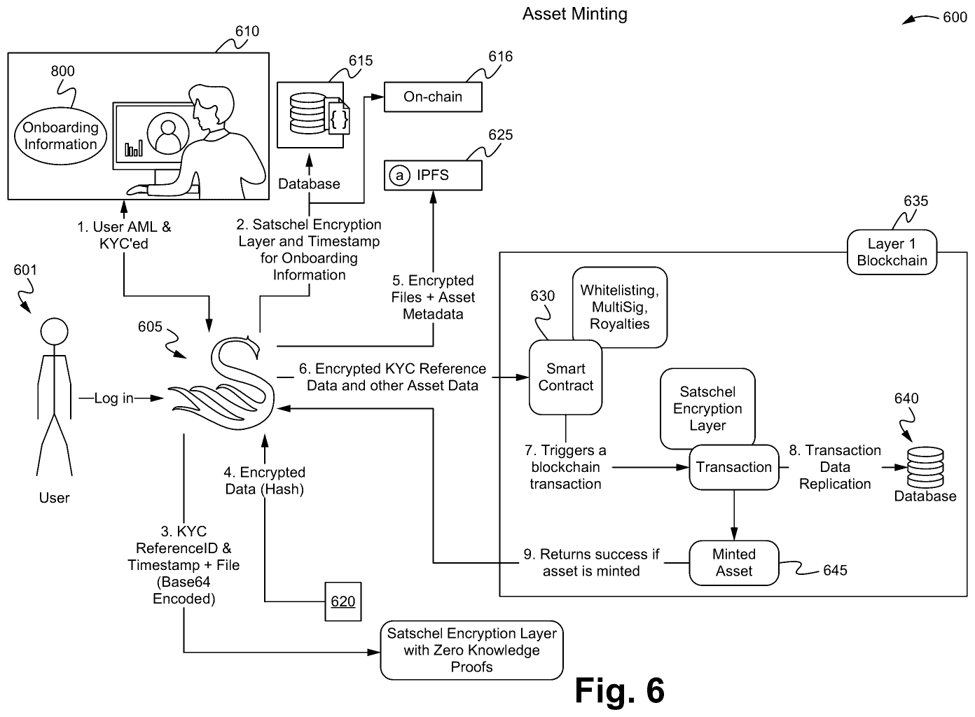

FIG. 6 is a high-level block diagram of a system 600 for verifying a user 601, e.g., determining that she is compliant and minting an asset, in accordance with embodiments of the invention. The system 600 includes a mobile application 605 coupled to a user Interface 610, a first Database 615, On-chain 616, an Encryption Service or Layer 620, a Smart Contract 630, a Layer 1 Blockchain 635, and a second Database 640. In some embodiments, the Encryption Layer 620 comprises a Proxy Re-Encryption using Zero-Knowledge Proofs. In some embodiments, the Encryption Layer 620 is a Satschel Encryption Layer provided by Satschel of San Francisco, California.

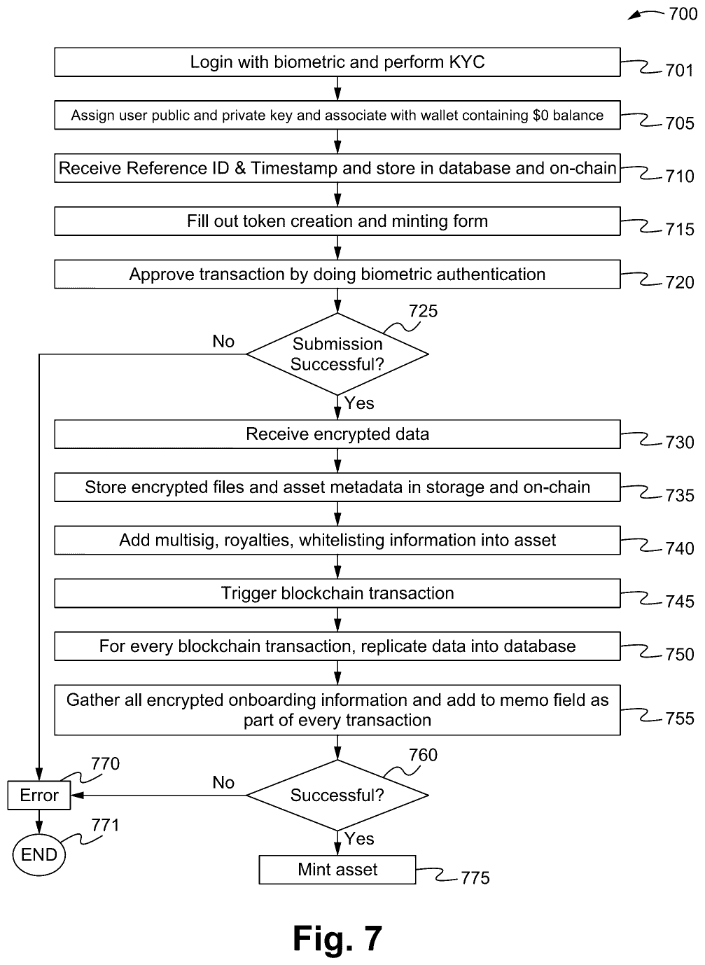

FIG. 7 shows the steps of a process 700 for minting an asset using the system 600. Referring to FIGS. 6 and 7, in a step 701, the first time a user logs into the system 600, she logs on with a biometric and performs KYC, such as described in the embodiments above. In the step 701, the system 600 collects onboarding information 800, such as described herein. In a step 705, public and private keys are associated with a wallet, which is initialized with a $0 balance. Next, in a step 710, the system 600 receives a ReferenceID and Timestamp (e.g., a subset of the onboarding information 800) from the KYC vendor and stores both in the database 615 and also on-chain 616. In a step 715, the user fills out a Token Creation and Minting Form, including, for example, information about the token, the token image and any needed files related to the token, multisig, royalties, and whitelisting information, and then submits the information.

Next, in a step 720, the user approves the transaction by performing biometric authentication, such as by using a biometric or facial scan. If, in the step 725, it is determined that the submission, including the biometric approval, was successful, the process continues to a step 730. If the submission was unsuccessful, the process continues to a step 770, where an error is logged, and from there the process continues to a step 771, where it ends.

Next, in a step 730, encrypted data from the Encryption Layer 620 is received on the mobile application 605, and in a step 735, the system stores the encrypted files and asset metadata in storage 625 and on-chain 616. As some examples the storage 625 includes InterPlanetary File System (“IPFS”) or another protocol and network system for sharing data in a distributed file system. After reading this disclosure, those skilled in the art will recognize other suitable databases that can be used in accordance with the embodiments.

As some examples, the asset metadata includes the symbol name, the image, and a royalties schedule. As one example, a royalties schedule is set as two basis points for each downstream sale of the asset for the asset creator. In some embodiments, once set, the first trade and any subsequent trades follow the same royalty schedule.

In some embodiments, the storage 625 includes permanent storage on third-party drives, such as IPFS. It will be appreciated that in accordance with other embodiments, other types of storage 625 can also be used.

Next, in a step 740, the system adds multisig, royalties, and whitelisting information to the asset using the Smart Contract 630. In a step 745, the system triggers the blockchain transaction. In a step 750, for every blockchain transaction, data is replicated into the database 640, and in a step 755, the system gathers all the encrypted information and other facts collected about an inventor and the asset during onboarding and adds it to the memo field (for simplicity, referred to as a “Onboarding” information”) as part of every transaction. In some embodiments, the Onboarding information includes KYC, KYB (“Know Your Business”), AML, Accreditation information and other facts about the investor acquired during onboarding, with reference IDs, including date and time stamps, lists of facts, the names of the vendors who provided the compliance services, and other information, excluding PII. In this way, each transaction provides additional transparency, in what is called “a compliance anchor.”

From the step 755, the process continues to a step 760, where the system determines whether the transaction was successful. If, in the step 760, it is determined that the transaction was successful, the process continues to a step 775, in which the asset is minted, now available for trading on exchanges. Otherwise, if it is determined the step 760 that the transaction was not successful, the process continues to the step 770.

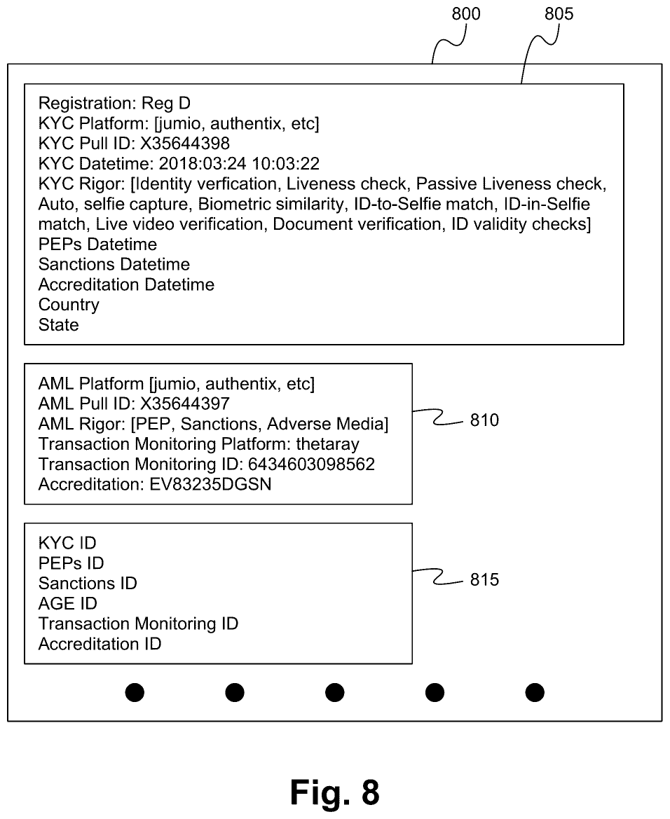

FIG. 8 shows onboarding information 800 in accordance with some embodiments, including KYC-AML verification information, as described below. The KYC-AML verification 800 includes a KYC component 805, an AML component 810, and a Zero Knowledge Proofs component 815. The KYC component 805 includes an offering type, the KYC Platform, the KYC Pull ID, the KYC date/time stamp, the KYC Rigor, the Politically Exposed Persons (PEPs) date/time stamp, Sanctions date/time stamp, Accreditations date/time stamp, and Country and State, the latter two fields used, for example, for payments, money transmission monitoring, and licensing done at the state level. The AML component 810 includes the AML Platform, the AML Pull ID, the AML Rigor, the Transaction Monitoring Platform, the Transaction Monitoring ID, and the Accreditation.

The Zero Knowledge Proofs component 815 includes KYC ID, KYB ID (if the transacting party is an entity), Politically Exposed Persons (PEPs) ID, AGE ID (indicating, for example, whether a verification/authentication is stale), Transaction Monitoring ID, and Accreditation ID. In some embodiments, the data in the Zero Knowledge Proofs component 815 is stored in an internal, secure database, allowing regulators and other authorized parties to associate a vendor with a user logging into the system to confirm a person's or entity's identity. This provides businesses with an aggressive layer of defense against those who violate laws or regulations. As indicated by the dotted lines in FIG. 8, typically onboarding information will include fields/components in addition to components 805, 810, and 815.

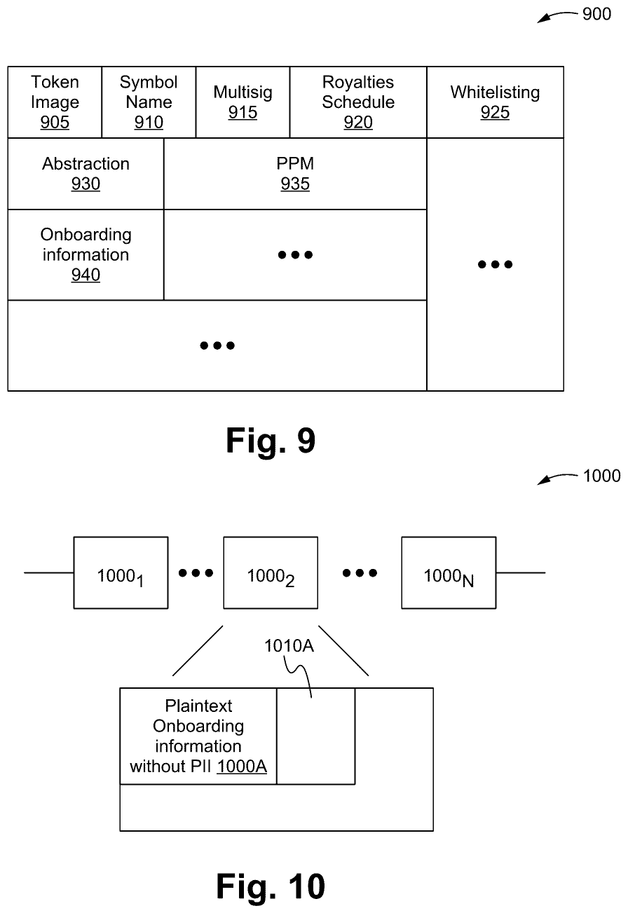

FIG. 9 is a block diagram of an asset 900 for inclusion on a blockchain, in accordance with some embodiments. The asset 900 includes a Token Image Field 905, a Symbol Name Field 910, a Multisig Field 915, a Royalties Schedule Field 920, a Whitlelisting Field 925, an Abstraction Field 930, a PPM Field 935, and an Onboarding Information Field 940. As some examples, the Onboarding Information Field 940 includes the KYC-AML verification block 801, which includes platforms, checks performed, and the testing platforms. The Onboarding Information Field 940 is viewable to the public in plain text. In this way, the token provides transparency about the trustworthiness and the authenticity of the party that owns the asset. That owner's identity, however, is abstracted by the identifier in the Abstraction Field 930.

In some embodiments, all details of the issuance are uploaded when the asset is created. Advantageously, the files are embedded when the token is issued.

It will be appreciated that the fields contained in the asset 900 are merely exemplary. Those skilled in the art will recognize other combinations of fields for a token in accordance with the spirit of the invention.

### Downstream Royalties

In accordance with some embodiments, when creating an asset in accordance with FIGS. 6-9, a user can allocate a percentage of the royalties generated, so that with every trade of the asset, whether on primary or secondary exchanges, a percentage of the royalties are allocated among different parties. As one example, the royalties are allocated by software instructions included in a Smart Contract. In some embodiments, the Smart Contract is a Ricardian contract.

As one example of a royalty schedule for downstream trades, the asset creator receives 3 basis points, a second party receives 2 basis points, and the system receives 5 basis points as a transaction fee. As another example, for each downstream trade, the asset creator receives 2 basis points, the second party receives 1 basis point, and the system receives 4 basis points. In typical embodiments, the system receives 1-5 basis points for each downstream transaction. In accordance with the present invention, the parties can agree to different royalty schedules.

In some embodiments, the royalties are sent to parties' wallets using a smart contract. In some embodiments, the Smart Contract comprises a Ricardian contract. FIG. 10 shows an exploded view of a node 1000₂ in a chain of nodes 1000₁ . . . . 1000_{N} in a blockchain network in accordance with some embodiments. (With the hash of the block and pointer to the next block, among other things, removed for simplicity.) The node 1000₂ includes an Onboarding Information Field 1000A in plain text (without PII) and a smart contract 1010A, which calculates downstream royalties.

### Embodiment Using an Adapter/Messaging System

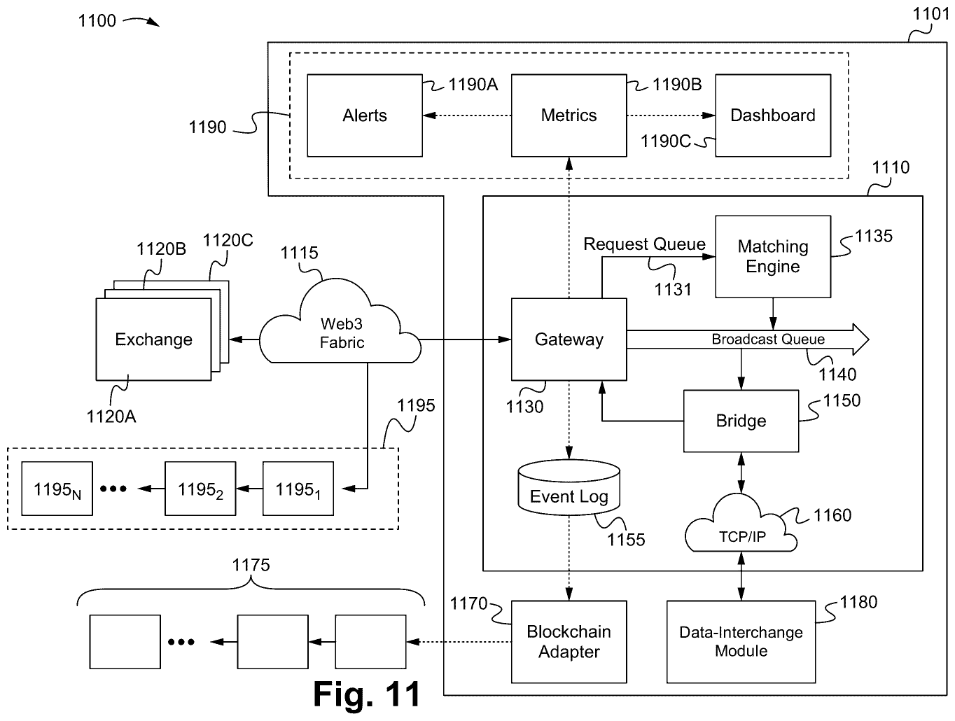

FIG. 11 is a block diagram of a system 1100, including a Platform 1101, for minting assets and receiving royalties, in accordance with some embodiments. The Platform 1101 is coupled over a Web3 Fabric™ networking structure 1115, to one or more Exchanges 1120A-C and a Private Blockchain Trading Platform 1195, described in more detail below. The Platform 1101 includes a Host 1110. The Host 1110 includes a Gateway 1130, a Matching Engine 1135, a Broadcast Queue 1140, a Bridge 1150, a TCP/IP Module 1160, and an Event Log 1155. The Gateway 1130 transmits data over a Request Queue 1131 to the Matching Engine 1135, which in turn transmits data to the Broadcast Queue 1140. In turn, the Broadcast Queue 1140 transmits data over the Bridge 1150 to the Gateway 1130. The Gateway 1130 also transmits event data to the Event Log 1155, and the Bridge 1150 exchanges data with the TCP/IP Communications Module 1160.

The Platform 1101 also includes a Blockchain Adapter 1170 for receiving data from the Event Log 1155 and transmitting data over a Blockchain Network 1175, a Data-Interchange Module 1180 for exchanging data with the TCP/IP Communications Module 1160, and a Monitoring Module 1190, including an Alerts Module 1190A, a Metric Module 1190B, and a Dashboard 1190C. The Metric Module 1190B receives data from the Gateway 1130 and transmits data to both the Alerts Module 1190A and the Dashboard 1190C.

In some embodiments, the Host 1110 uses a Linux Operating System, the Data-Interchange Module 1180 encodes data in FIX and Java Script Object Notation, and the Matching Engine 1135 is programmed in a computer language that supports parallel algorithms, such as C++ 17. It will be appreciated that other operating systems, data-interchange formats, and computer languages with other capabilities are also contemplated.

In operation, a user initializes the Platform 1101 and logs on, as illustrated in FIGS. 1-3. Later, the user enters data so that the Platform 1101 can verify the user's identity using KYC, as described above. Next, the user mints assets, as illustrated above.

Next, referring to FIG. 11, as part of minting an asset in accordance with the embodiments of the invention, a token template is generated using the Data-Interchange Module 1180, transmitted to the Host 1110 over the TCP/IP Communications Module 1160, and to the Bridge 1145, which forwards it over the Gateway 1130. The Gateway 1130 then forwards the token over the Request Queue 1131 to the Matching Engine 1135, which applies strategies for listing the token, determining, for example, on which ones of the Exchanges 1120A-C to list the token, how many tokens to list, etc. Next, the Matching Engine 1135 forwards the token over the Broadcast Queue 1140 to the Bridge 1150, which forwards the token to the Gateway 1130. The Gateway 1130 then forwards the token to both the Web3 Fabric™ networking structure 1115 and the Blockchain Adapter 1170. The Web3 Fabric™ networking structure 1115 forwards the token to the selected one or more of the Exchanges 1120A-C for listing.

Once the asset has been traded on the selected one or more Exchanges 1120A-C, the transaction is transmitted from the selected Exchanges 1120A-C, over the Web3 Fabric™ networking structure 1115, to the Gateway 1130, and to the Event Log 1155, over the Blockchain Adapter 1170, and then to the Blockchain 1175.

The Blockchain 1175 records token purchases and, in some embodiments, also incorporates Smart Contracts. In some embodiments, the Smart Contracts are used to determine downstream royalties so that the original owner of an asset receives a specified amount for each downstream sale of a token according to a royalties schedule. For example, if user A buys a token, the original owner will receive 2 basis points. If the user A later sells the token to user B, the original owner receives 1 basis points for that second transaction and any later ones.

It will be appreciated that regulations for banks differ from those for public securities exchanges. As one example, payments for banks on blockchain must be private, thereby preventing real-time runs on banks and other actions that compromise the integrity of the banking systems. To accomplish this, banking regulations impose certain requirements on banks that process transactions on blockchains, such as requiring that the blockchains are private, not viewable by the public. Thus, in some embodiments, the system 1100 includes the Private Blockchain Trading Platform 1195 for processing banking payments, such as one implemented by the USDF Consortium™, which uses Stablecoins digital assets built and funded by the Consortium members. In some embodiments, the Private Blockchain Trading Platform 1195 is generated by forking Polygon, which uses Zero-Knowledge Proofs built into its transaction platform.

As one example, the Private Blockchain Trading Platform 1195 comprises nodes 1195₁-1195_{N}, where N is any integer and each of the 1 . . . N nodes is controlled by an associated one of the USDF Consortium™ members. In some embodiments, the Consortium controls the entire Blockchain Trading Platform 1195.

The Monitoring Module 1190 monitors transactions to determine metrics (1190B) to generate alerts (1190A) and provide user data on the Dashboard (1190C).

Embodiments of the invention provide transparency at the transaction level. For example, on the selected one or more exchanges, regulators can see the transactions, the wallets that funds are transferred into and out of, the countries from which the payment originated and was deposited, the types of compliance checks (e.g., AML and KYC) that were performed, who performed the compliance checks, etc. It will be appreciated that other onboarding information will also be publicly viewable. However, no personal identifying information is viewable by the public. Only abstractions of user IDs of a person are identified.

In different embodiments, the steps of the flowcharts described above are implemented on computer-readable media storing instructions that when executed by a processor perform one or more of the steps. It will also be appreciated that any one or more of the hardware components in FIGS. 1, 4, 6, and 11 include a processor and computer-readable media for executing the functionality of the components.

Some embodiments of the invention are directed to using multiple keys to sign transactions to verify their authenticity. The following description will describe storing and retrieving keys and, later, financial regulatory compliance and Zero Knowledge Proofs on a public blockchain.

In accordance with some embodiments, private keys are stored in a “cold wallet,” such as described in U.S. Pat. No. 11,468,435, titled “Apparatus and Methods of Air-Gapped Crypto Storage Using, Diodes,” which is hereby incorporated by reference in its entirety. In accordance with some embodiments, a user may store her private key in a Hardware Security Module (HSM) accessible over a secure pathway using diodes or other high-speed one-way devices. In accordance with some embodiments, a user may combine the KYC, AML, KYB and other security measures described above with other storage and retrieval methods and systems. For example, in some embodiments, a user may verify her identity using the KYC, AML, KYB, and other methods described above, retrieve her private key stored in an HSM, such as by using a “cold wallet,” and sign data, such as financial transactions on a blockchain.

In a blockchain network, a “cold wallet” allows users to securely create and store their private key and sign their transaction data only when the wallet is completely offline. In contrast to existing cold wallets, which are typically implemented as a single-tenancy device at the client side, embodiments of the invention allow secure private key storage with multi-tenancy and can be deployed at an on-premise data center. A one-way diode data path and a synchronized “pulse” mechanism in accordance with embodiments of the invention ensure 1) a cold wallet can never be hijacked by an Internet malicious actor because the de facto Internet protocol (TCP) and other interactive protocols are physically disabled at all times; 2) the private key signing process can only occur when the cold wallet is completely offline; 3) the key exists in the HSM only when the HSM is offline, that is, the key can always be offline; and 4) high performance.

In some embodiments, when a user requests a transaction, a user key tag that identifies the user's key is determined. The transaction data and the user's key tag are transmitted to a cold wallet that includes an HSM Trusted Client and an HSM over a first one-way communication channel during a window in a first sequence of connection windows. Inside the cold wallet, the HSM Trusted Client uses the user key tag to determine an encrypted version of the user's signing key. During a processing window, the transaction data and encrypted signing key are transmitted to the HSM, where a cleartext key is recovered and used to sign the transaction, and the signed transaction is transmitted back to the HSM Trusted Client. During a second connection window, the signed transaction is transmitted from the HSM Trusted Client for transmission to the blockchain network. The processing and connection windows do not overlap. The one-way communication paths combined with the non-overlapping connection and processing prevent unauthorized access to the signing keys.

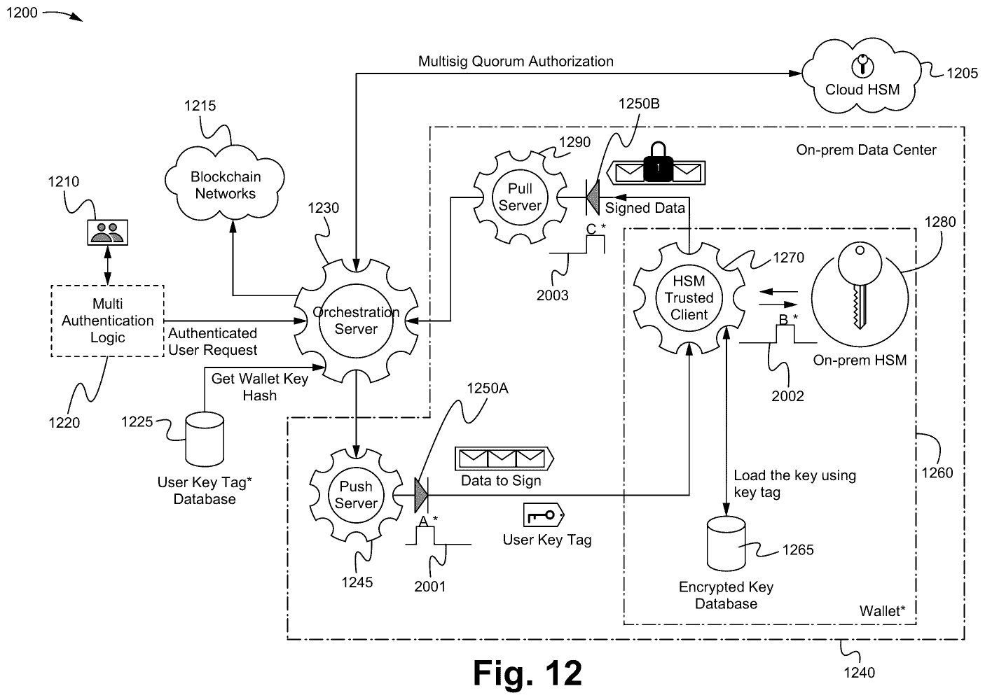

FIG. 12 shows a schematic diagram of a system 1200 in accordance with some embodiments of the invention. The system 1200 includes an Orchestration Server 1230 coupling a cloud of hardware security modules (HSMs) 1205, blockchain networks 1215, multi-authentication logic 1220, a User Key-Tag database 1225, and an on-premises Data Center 1240. Among other things, the Orchestration Server 1230 queues transaction data and associated key-tags for transmission to the Data Center 1240. The Data Center 1240 includes a Push Server 1245 coupled to the Orchestration Server 1230, a first diode 1250A for one-way transmission from the Orchestration Server 1230 to a Wallet 1260, a second diode 1290 for one-way transmission from the Wallet 1260 to a Pull Server 1290 coupled to the Orchestration Server 1230.

The Wallet 1260 includes an HSM Trusted Client 1270 coupled to an Encrypted Key Database 1265 and an on-premises HSM 1280. The HSM Trusted Client 1270 is coupled to the Push Server 1245 over the first diode 1250A and to the Pull Server 1290 over the second diode 1250B. In some embodiments, all the components of the Data Center 1240 are collocated on the same premises.

In some embodiments, the transmissions from the Orchestration Server 1230 to the Push Server 1245 and from the Pull Server 1290 to the Orchestration Server 1230 are both according to Transport Layer Security (TLS) protocol. In some embodiments, transmissions from the Push Server 1245 to the first diode 1250A and from the second diode 1250B to the Pull Server 1290 are both according to user datagram protocol (UDP). In other embodiments protocols other than UDP and TLS are contemplated.

The first diode 1250A allows data to be transmitted from the Push Server 1245 to the HSM Trusted Client 1270 but prevents data from being transmitted in the opposite direction, from the HSM Trusted Client 1270 to the Push Server 1245. Similarly, the second diode 1250B allows data to be transmitted from the HSM Trusted Client 1270 to the Pull Server 1290 but prevents data from being transmitted from the Pull Server 1290 to the HSM Trusted Client 1270. In this way, the first diode 1250A and the second diode 1250B provide one-way transmission paths.

In some embodiments, the first and second diodes 1250A and 1250B are fast-switching diodes, such as insulated-gate bipolar transistor (IGBT) diodes, though other suitable diodes can also be used.

In some embodiments, the only data path from the Internet to the Wallet 1260 is from the Push Server 1245 through the first diode 1250A to the HSM Trusted Client 1270, and the only data path from the Wallet 1260 to the Internet is from the HSM Trusted Client 1270 through the second diode 1250B to the Pull Server 1290. In some embodiments, the only data path to the on-premises HSM 1280 is through the HSM Trusted Client 1270.

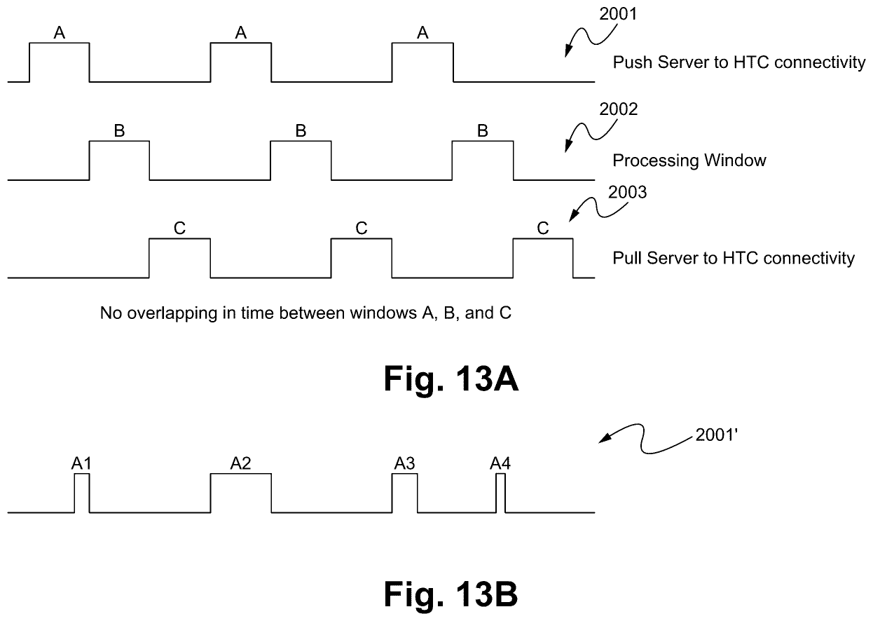

As explained in more detail below, the first diode 1250A transmits data only when it is turned ON, such as by being energized, thereby connecting the Push Server 1245 to the HSM Trusted Client 1270, allowing data to be transmitted from the Push Server 1245 to the HSM Trusted Client 1270. (This is also referred to as providing “connectivity” between the Push Server 1245 and the HSM Trusted Client 1270.) When the first diode 1250A is turned OFF, the Push Server 1245 cannot transmit data to the HSM Trusted Client 1270. FIG. 12 shows a segment of a pulse train 2001 for turning the first diode 1250A ON during a window A and OFF otherwise. Typically, the first diode 1250A will be turned ON (indicated by the sequences labeled “A”) and OFF sequentially, as shown in more detail in FIG. 13A, which shows a longer portion of the pulse train 2001.

In a similar manner, the HSM Trusted Client 1270 is connected to the HSM 1280 only during a window B (“processing windows”) of a pulse train 2002. Again, FIG. 13A shows a longer portion of the pulse train 2002. Referring to FIG. 13A, connectivity between the HSM Trusted Client 1270 occurs during each window B in the pulse train 2002. In some embodiments, only during a single window B (that is, not extending over multiple windows B), transaction data and a user's encrypted signing key can be transmitted from the HSM Trusted Client 1270 to the HSM 1280, the HSM 1280 recovers the cleartext signing key and uses it to sign the transaction data, and the signed transaction data is transmitted from the HSM 1280 to the HSM Trusted Client 1270.

Finally, in a similar manner, a pulse train 2003 includes a window C from a sequence of connection windows in a pulse train 2003 during which data can be transmitted over the second diode 1250B from the HSM Trusted Client 1270 to the Pull Server 1290. Data cannot be transmitted from the HSM Trusted Client 1270 over the second diode 1250B, and to the Pull Server 1290 outside any of the windows C. Again, FIG. 13A shows a longer portion of the pulse train 2003.

In some embodiments, none of the windows A, B, and C overlap with each other. In other words, none of the separate windows A overlap with any of the windows B and C, and none of the windows B and C overlap with each other.

In some embodiments of the invention, the system 1000 is configured as a “pipeline” structure to increase throughput. Referring to FIGS. 12 and 13A, in accordance with these embodiments, transaction data for multiple transactions are transmitted over the first one-way transmission path during a window A and queued on the HSM Trusted Client 1270 as a batch of “sign requests.” During a window B, the multiple sign requests, each including transaction data and a corresponding wrapped/encrypted signing key or signing key identification, are pushed from the HSM Trusted Client 1270 to the HSM 1280. During further processing, for each transaction, a cleartext key is recovered inside the HSM 1280 and the transaction data signed to generate a signed transaction, which is then transmitted to and stored at the HSM Trusted Client 1270. Next, during a window C, the multiple signed transactions are transmitted from the HSM Trusted Client 1270, as a batch (e.g., together), over the second diode 1250B, to the blockchain network 1215. In these embodiments, to ensure that the signing keys are kept offline, the window A can overlap with the window C, but the window B cannot overlap with the windows A or C.

In yet another pipeline structure in accordance with embodiments of the invention, transaction data are transmitted to and from the HSM Trusted Client 1270 in discrete windows, but again queued on the HSM Trusted Client 1270 as a batch of sign requests for processing on the HSM 1280. To simplify the discussion, referring to FIGS. 12 and 13A, the transmission of transaction data for a transaction X over the first diode 1250A to the Wallet 1260 (e.g., during a window A) is referred to as A_{X}, the processing of a transaction Y within the Wallet 1260 (e.g., during a window B) is referred to as B_{Y} and the transmission of a signed transaction Z from the Wallet 1260 across the second diode 1250B to the blockchain network 1215 (e.g., during window C) is referred to as C_{Z}.

In some embodiments, any two or more of A_{X}, A_{Y}, A_{Z}, C_{X}, C_{Y}, and C_{Z} can overlap. That is, transaction data and signed transactions can be transmitted to and from the Wallet 1260 at the same time. Also, any two or more of B_{X}, B_{Y} and B_{Z} can overlap. However, to ensure that signing keys are never online in cleartext format, none of B_{X}, B_{Y} or B_{Z} can overlap with any of A_{X}, A_{Y}, A_{Z}, C_{X}, C_{Y}, and C_{Z}. That is, when transaction data is being processed in the Wallet 1260, the first diode 1250A and the second diode 1250B are both OFF.

As one example, the HSM Trusted Client 1270, the HSM 1280, or both are configured with multiple processors functioning in parallel, or by a single processor configured for multitasking (e.g., using time slices), multithreading, or any combination of these, thereby allowing the Wallet 1260 to process transactions in parallel.

In operation of these pipeline embodiments, a batch of transaction data each with a different key are queued in the HSM Trusted Client 1270. These sign requests can be pushed to the HSM 1280 sequentially or simultaneously, such as over parallel transmission lines, in an interleaved structure, or in a similar manner. Any one or more of the following can be performed for multiple transactions in parallel: recovering wrapped/encrypted keys for transactions in the HSM Trusted Client 1270, transmitting transaction data and the wrapped/encrypted keys from the HSM Trusted Client 1270 to the HSM 1280, recovering the cleartext signing keys in the HSM 1280, signing transactions within the HSM 1280 to generate signed transactions, and transmitting signed transactions from the HSM 1280 to the HSM Trusted Client 1270.

Referring to FIG. 12, it will be appreciated that while the timing diagrams 2001-2003 show positive pulses (e.g., a+5V input or other signal to the first diode 1250A), the windows A, B, and C can have negative (e.g., −5V) or other values to energize the diodes 1250A and 1250B and transmission paths to allow transmission of data. Also, while the pulse trains 2001-2003 all have constant periods and window widths, it will be appreciated that any of the windows A, B, and C in the sequences of windows can have varying widths, varying frequencies, or both, so long as none of the windows overlap. FIG. 13B, for example, shows a pulse train 2001′ having windows of varying widths A1, A2, A3, A4, etc., and varying periods for energizing the first diode 1250A, in accordance with some embodiments of the invention. The windows B and C can have similar characteristics.

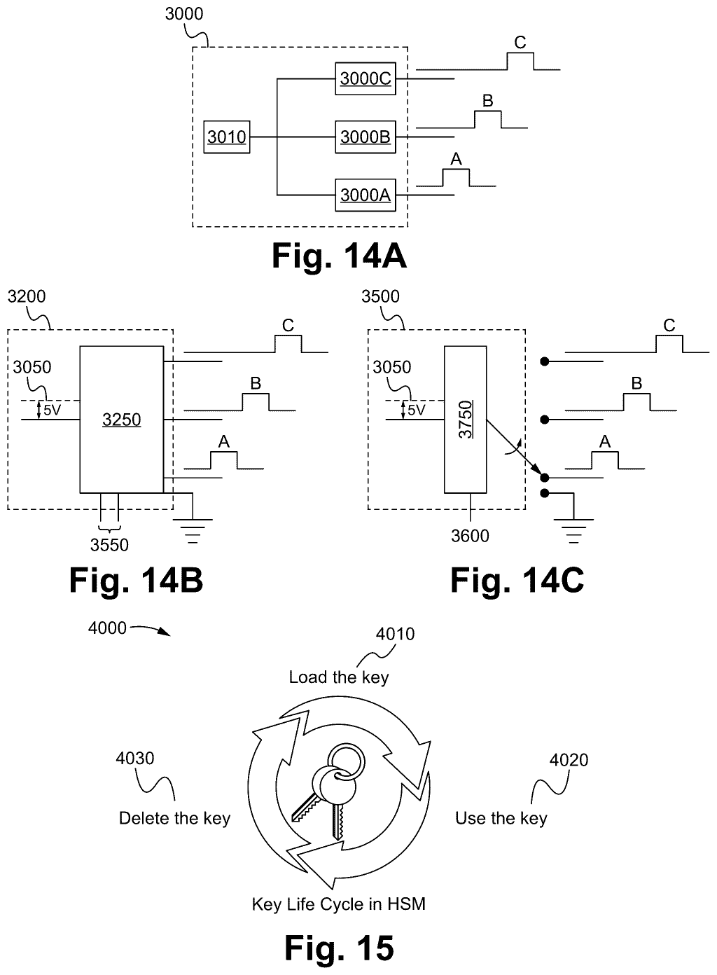

It will be appreciated that the windows A, B, and C can be generated in several ways, such as by pulse trains. (Because the windows A, B, and C can be generated by pulse trains, the terms “windows” and “pulse trains” are used interchangeably.) FIGS. 14A-C show windows generators in accordance with embodiments of the invention. FIG. 14A shows clocks 3000A, 3000B, and 3000C for generating windows (here, clock signals) A, B, and C, respectively. Referring to FIGS. 12 and 14A-C, in some embodiments, the window A is coupled to the first diode 1250A (or functional equivalent, as described in the different embodiments), the window B is coupled to the HSM Trusted Client 1270/HSM 1280, and the window C is coupled to the second diode 1250B. The clocks 3000A, 3000B, and 3000C are coupled to and synchronized with a central/master clock 3010. FIG. 14B shows a windows generator 3200 that includes a multiplexer 3250 that receives a composite clock signal 3050 (here, a +5 VDC signal) on its input line. Using the selectors 3550, the composite signal 3050 can be divided into windows A, B, and C, including a ground that that allows the signals A, B, and C to be non-contiguous. FIG. 14C shows a windows generator 3500 that includes a 4-way (SP4T) switch 3750 that receives the composite clock 3050 as input and sequentially (rotationally) couples the input signal to separate lines for dividing the composite signal 3050 to generate the windows A, B, and C. After reading this disclosure, those skilled in the art will recognize other ways of generating non-overlapping windows in accordance with embodiments of the invention.

As described in more detail below, a key tag is used to determine the user's signing key within a wallet for signing in an HSM. The key tag is an identification for the user key. It provides one-to-one mapping between a user and her actual private key. Referring to FIG. 12, in one embodiment, the user key-tag database 1225 associates the user's account identity with a key tag. At an Encrypted Key database inside a wallet (e.g., 1265), the user key tag is used to determine the encrypted user private key.

The private key cannot be derived from the key tag. In some embodiments, keys are periodically rotated, thereby constantly updating the associated key tags. In other embodiments, to ensure that the user-facing key tag is constant, the key-tag to encrypted key mapping is also periodically updated.

In different embodiments, a key tag can be a key index or a hash number calculated from an encrypted private key.

Key tags can be associated with particular keys for any predetermined length of time on the client side, reducing the “rekeying” process. Alternatively, clients are able to determine their own keys (referred to as “Bring Your Own Key,” or BYOK), thereby allowing them to control the life cycle of their own keys. Alternatively, users are able to create their own key tags on the client side and store the key tags on a user device. After reading this disclosure, those skilled in the art will recognize other ways to store, generate, update, and associate keys and associated key tags.

In one embodiment, once a key (i.e., cleartext key) has signed data in the HSM 1280, the key is deleted within a predetermined period within the HSM 1280. Thus, even if the HSM is compromised, a malicious attacker cannot access a signing key. FIG. 15 shows the phases of a lifecycle 4000 for a signing key for signing transaction data in the HSM 1280 in accordance with some embodiments of the invention.

Referring to FIGS. 12 and 15, in a phase 4010, the HSM 1280 imports the transaction data and the wrapped private key. In a second phase 4020, the HSM 1280 signs the transaction data with the cleartext private key and transmits the signed transaction data to the HSM Trusted Client 1270. Optionally, in a third phase 4030, after the HSM 1280 signs the transaction data and transmits the signed transaction data to the HSM Trusted Client 1270, the HSM 1280 deletes the private key within a predetermined period, such as immediately, 1 ms, 1 second, or any other suitable time period T_{SMALL}. In this way, even with the tamper-resistant HSM boundary, the cleartext private key exists in the HSM 1280 for only a minimal period, and in no event longer than the processing window (e.g., the width of the window B). In some embodiments, the phases 4010, 4020, and 4030 all occur within a single window B.

In some embodiments, the HSM 1280 is configured to retain some private keys for longer periods T_{LARGE}>T_{SMALL} (or not to delete the keys at all) based on a user's profile and predetermined characteristics, such as when the private keys are used often (within predetermined time periods) and only for small transaction amounts (e.g., all less than a predetermined sum, such as $10USD). In this case, the private keys are considered associated with a “Hot Wallet” and are cached in the HSM 1280 to improve performance. As some examples T_{LARGE}=1 hour, 1 day, or one week, to name only a few examples. In some embodiments, a user's profile includes parameters such as the user's ID, a field (e.g., flag) indicating that the user opts to store her key for the duration T_{LARGE}, the duration T_{LARGE}, a transaction amount for triggering the longer-term storage, or any other suitable parameters. These parameters are merely illustrative. Those skilled in the art will recognize other parameters that can be stored in a user's profile instead of or in addition to those described here.

The policy of distinguishing a performance oriented “Hot Wallet” and a security-oriented “Cold Wallet” can be decided either automatically based on machine/deep learning analytics or simply selected by the user.

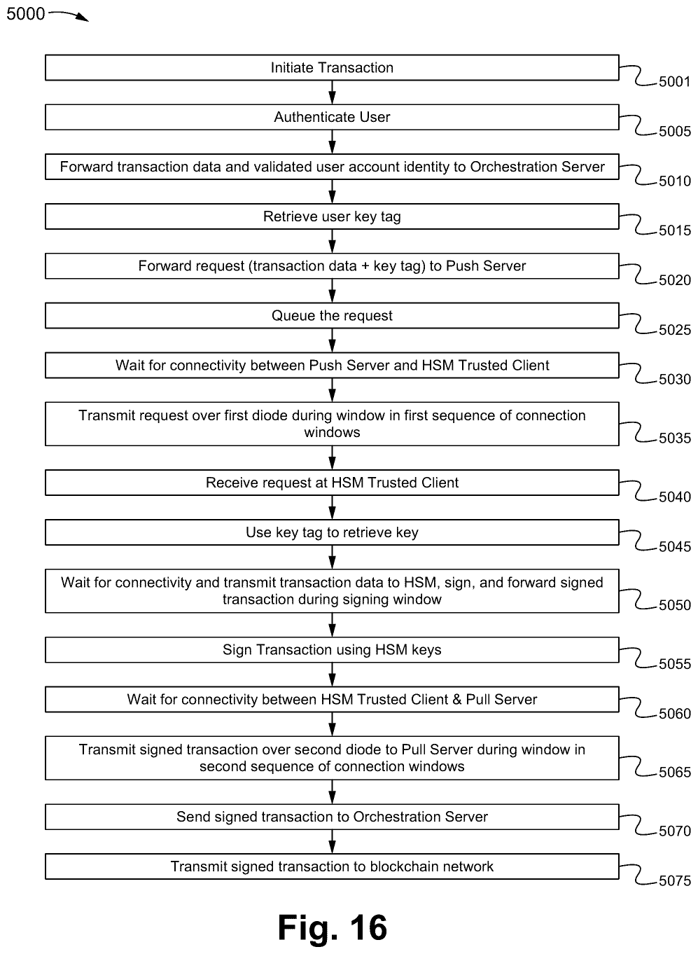

FIG. 16 shows the steps S000 of a method of signing transaction data using the system 1200 in accordance with one embodiment of the invention. The system 1200 is referenced merely to explain the method and in no way limits the scope of the invention. In a step S001, a user 1210 initiates a transaction to be made over a blockchain network 1215, such as paying money to another user's wallet or depositing money into his own wallet, to name only a few transactions. In a step S005, the user is authenticated using the multi-authentication logic 1220. As one example, the user must be able to authenticate himself multiple times until his identity and transaction are both validated.

In a step S010, the authenticated request, including the transaction data to sign and the user's validated account identity, is forwarded to the Orchestration Server 1230. The Orchestration Server 1230 is essentially a hub to orchestrate multiple operations to fulfill the original request. Next, in a step S015, the Orchestration Server 1230 queries the user key-tag database 1225 to determine a key tag for the user based on the verified user identity.

Next, in a step S020, the Orchestration Server 1230 forwards the transaction data and key tag (together, a “request”) to the Push Server 1245 using a first transmission protocol, such as the TLS protocol. In a step S025, the Push Server 1245 queues the request for transfer to the Wallet 1260. The Push Server 1245 is essentially a request queuing service for relaying the actual key signing data from the Orchestration Server 1230 to the HSM 1280. In some embodiments, the Push Server 1245 is trusted by the Orchestration Server 1230.

In the Data Center 1240, in a step S030, the Push Server 1245 waits until its connectivity to the Wallet 1260 is “UP,” that is during a window in a first sequence of connection windows (e.g., any of the windows A in FIG. 13A). During a window A, in the step S035, the Push Server 1245 transmits the request to the HSM Trusted Client 1270 unidirectionally over the first diode 1250A. It will be appreciated that data can only be sent to the HSM Trusted Client 1270 over the first diode 1250A and only during a window A. Any attempts to transmit data to the HSM 1280 over other channels or outside windows A are prevented. Data is transmitted from the Push Server 1245 over the first diode 1250A to the HSM Trusted Client 1270 using a second transmission protocol, such as UDP. UDP prevents a malicious actor from remotely controlling the Push Server 1245 and the associated HSM 1280.

In a step S040, the HSM Trusted Client 1270 receives the request. Next, in a step S045, the HSM Trusted Client 1270 uses the key tag to retrieve the encrypted private key from the Encrypted Key database 1265. The encrypted private key is encrypted using an HSM generated wrapping key. No one, not even the HSM operator, is able to decipher the private key in cleartext outside the security world boundary of the on-premises HSM 1280.

Next, in a step S050, the HSM Trusted Client 1270 waits until the connectivity to the HSM 1280 is UP, that is, during a window in a sequence of processing windows (e.g., any of the windows B in FIG. 13A). During the window, the HSM Trusted Client 1270 transmits the transaction data and encrypted private key to the HSM 1280, where the HSM 1280 decrypts the private key to recover the cleartext signing key, signs the transaction data with the key, and transmits the signed transaction to the HSM Trusted Client 1270. Next, in a step S055, the transaction is signed using the HSM keys. Next, in a step S060, the HSM Trusted Client 1270 waits until the connectivity to the Pull Server 1290 is “UP,” that is, during a window in a sequence of second connection windows (e.g., any of the windows C in FIG. 13A). In a step S065, the HSM Trusted Client 1270 sends the signed transaction over the second diode 1250B to the Pull Server 1290. The second diode 1250B reinforces the unidirectional connection from the HSM Trusted Client 1270 to the Pull Server 1290, ensuring that a hacker cannot remotely control the HSM Trusted Client 1270 and its associated HSM 1280. Further, because the windows A, B, and C do not overlap, while the Pull Server 1290 pulls data from the Wallet 1260, no signing (since this is outside the signing windows B) occurs in the Wallet 1260.

Next, in a step S070, the Pull Server 1290 forwards the signed transaction to the Orchestration Server 1230. In some embodiments, a multi-signature authorization is enforced using a multi-signature wallet. A multi-signature wallet is a wallet in which control over multiple private keys is required to spend from that wallet. In other words, an address in the wallet has multiple private keys behind it. The idea with multi-signature wallets is that multiple people or entities can cooperatively control the funds in the wallet. The “M” of “N” multi-signatures (where M≤N, and M and N are both integers) can be implemented with “N” HSMs acting as controlling entities of which “M” signatures are required to process transactions.

In a multi-signature embodiment, the Orchestration Server 1290 will request another signature from a different HSM located in a different area of the on-premises HSM 1280. Multi-signature authorizations are described in U.S. Pat. No. 11,461,565, issued Oct. 4, 2022, and titled “Apparatus and Methods for Remote Controlled Cold Storage of Digital Assets Using Near Field Communication Tags,” which is hereby incorporated by reference in its entirety. Alternatively or additionally, this multi-signature requirement is satisfied by one or more cloud HSMs 1205 from different vendors. In some embodiments, when using different HSMs for this multi-signature requirement, different operators are assigned to manage the different HSMs. This way, it is ensured that no one HSM operator has access to all the keys required for a transaction.

In a step S075, once all the signatures are collected, the Orchestration Server 1290 pushes the signed transaction to any blockchain networks 1215 for the ledgering.

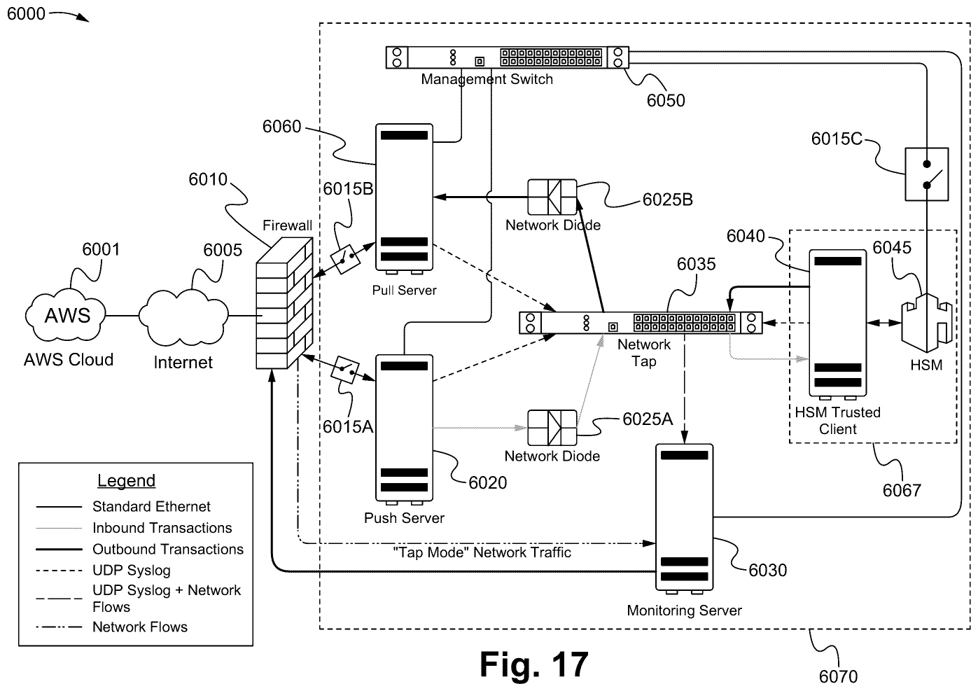

Other embodiments of the invention are adapted to provide additional security and to monitor transactions over a system such as the system 1200 in FIG. 12. FIG. 17 is a high-level diagram of a firewall system 6000 deployed in a network for securely signing transaction data in accordance with embodiments of the invention. The system 6000 includes components for monitoring traffic and other metrics, and for seamlessly inserting, removing, or switching components for ease of use, repair, replacement, etc.

The system 6000 includes an amazon® Web Services (AWS) Cloud 6001 coupled to the Internet 6005. The AWS Cloud 6001 provides on-demand computing platforms and application programming interfaces for services. The Internet 6005 is coupled over a Firewall 6010 to a Data Center 6070. The Data Center 6070 includes first, second, and third switches 6015A-C, respectively, a Push Server 6020, a Pull Server 6060, first and second network diodes (i.e. one-way transmission elements) 6025A and 6025B, respectively, a Network Tap 6035, a Management Switch 6050, a Monitoring Server 6030, and a Digital Wallet 6067 that includes an HSM Trusted Client 6040 coupled over a two-way transmission path to an HSM 6045.

The Firewall 6010 is coupled to the first and second switches 6015A and 6015B, which allow the Firewall 6010 to be seamlessly connected and disconnected from the Push Server 6020 and the Pull Server 6060, respectively. The first network diode 6025A couples the Push Server 6020 over a one-way connection to the Network Tap 6035, and the second network diode 6025B couples the Network Tap 6035 over a one-way connection to the Pull Server 6060. The Push Server 6020 and the Pull Server 606 are also directly coupled to the Network Tap 6035 for transmitting UDP Syslog data. The Network Tap 6035 is coupled to the HSM Trusted Client 6040 to transmit inbound transactions to the HSM Trusted Client 6040, to receive UDP Syslog data from the HSM Trusted Client 6040, and to receive outbound transactions from the HSM Trusted Client 6040. The Management Switch 6050 is coupled to the Push Server 6020, the Pull Server 6060, the Monitoring Server 6030, and, over the third switch 6015C, to the HSM 6045.

The Monitoring Server 6030 is coupled to the Firewall 6010 to receive “Tap Mode” Network Traffic and to transmit outbound transactions. The Monitoring Server 6035 is also coupled to receive UDP Syslog+Network Flows from the Network Tap 6035.

Similar components of the system 6000 operate similarly to those of the system 1200. For example, the Pull Server 6020 and Push Server 6060 have the same or similar functionality as the Push Server 1245 and 1230, respectively; the first and second network diodes 6025A and 6025B have the same or similar functionality as the first and second diodes 1250A and 1250B; the HSM Trusted Client 6040 has the same or similar functionality as the HSM Trusted Client 1270; and the HSM 6045 has the same or similar functionality as the HSM 1280.

In operation, the Firewall 6010 offers additional security to the on-premises Data Center 6070. The first, second, and third switches 6015A-C and the Management Switch 6050 allow any of the components coupled to them (e.g., Push Server 5020, Pull Server 5060, HSM 6045 and Monitoring Server 5030) to be disconnected, preventing transmission of any data through the component. The Monitoring Server 6030 monitors network traffic and other metrics.

While the above examples describe using diodes, such as IGBT diodes, to form the one-way communication channels 1250A and 1250B, it will be appreciated that other embodiments use other one-way communication elements using other suitable transmission protocols. In different embodiments, the one-way communication channels each includes a laser coupled over an air gap to a photodiode, an ultrasound speaker coupled over an air gap to a matching microphone, or an NFC write module (e.g., tag) coupled over an air gap to an NFC read (e.g., active) module, to name only a few examples. For the embodiments incorporating ultrasound speaker/microphone pairs, the ultrasound is used to modulate information and pass the data along a path via a speaker across the air gap to an ultrasensitive microphone. In some embodiments, for each wireless embodiment, the air gap is shielded against eavesdroppers, such as with a light insulator (e.g., for the laser/photodiode pairs), a sound insulator (e.g., for the ultrasound speaker/microphone pairs), a magnetic shield (for the NFC read/write modules), or by any other suitable means. Air-Gapped Near-Field Communication Tags are described in U.S. Pat. No. 11,461,565, incorporated by reference above.

In still other embodiments, the one-way communication channels incorporate steganographic means (e.g., coder/decoder), by which data is hidden/concealed in files, messages, images, or video, thereby hidden from potential eavesdroppers, and later recovered/extracted, as described below.

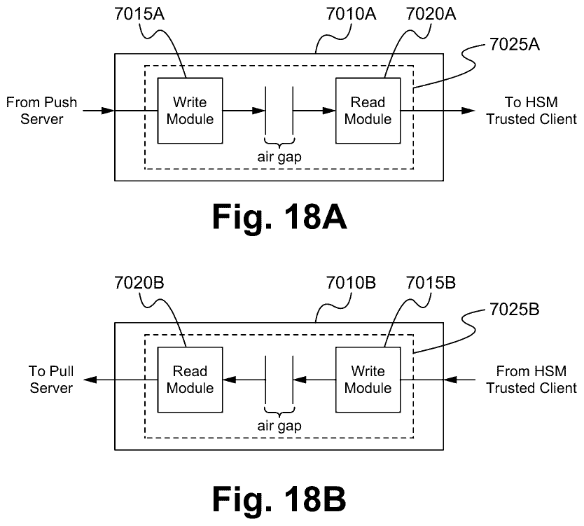

FIG. 18A, for example, shows a first wireless one-way communication channel 7010A for transmitting data from the Push Server 1245 to the HSM Trusted Client 1270, and FIG. 18B shows a second wireless one-way communication channel 7010B for transmitting data from the HSM Trusted Client 1270 to the Pull Server 1290. (To better illustrate the explanation, the descriptions refer to FIG. 12, in which the first diode 1250A is replaced by the first one-way communication channel 7010A, and the second diode 1250B is replaced by the second one-way communication channel 7010B.) The first channel 7010A includes a write module 7015A that receives data (e.g., transaction data and key tags) from the Push Server 1245 and transmits the data over an air-gap to a read module 7020A, which transmits the data to the HSM Trusted Client 1270. Similarly, the second channel 7010B includes a write module 7015B that receives data (e.g., a signed transaction) from the HSM Trusted Client 1270 and transmits the data over an air gap to the read module 7020B, which transmits the data to the Pull Server 1290.

In some embodiments, the write modules 7015A and 7015B each includes a laser or other light source and the read modules 7020A and 7020B each includes a paired/matched photodiode configured to read optical signals from the laser or light source. The paired modules 7015A/7020A and 7015B/7020B communicate using optical-signal protocols such as Synchronous Optical Networking (SONET), Synchronous Digital Hierarchy (SDH), and Optical Transport Network (OTN), to name only a few such protocols. In other embodiments, the write modules 7015A and 7015B each includes an ultrasound speaker and the read modules 7020A and 7020B each includes an ultrasonic microphone. The write module 7015A for example modulates a signal containing data and its corresponding microphone 7020A demodulates the signal to recover the data. In yet other embodiments, the write modules 7015A and 7015B each includes an NFC tag and the read (e.g., active) modules 7020A and 7020B each includes circuitry for reading NFC tags. The paired modules 7015A/7020A and 7015B/7020B operate using an NFC protocol. In other embodiments, the write modules 7015A and 7015B function using steganography by generating content (e.g., images) and hiding the data within the content. The matching read modules 7020A and 7020B, respectively, use specific algorithms to recover the hidden data.

In some embodiments, the air gaps in the transmission modules 7010A and 7010B are enclosed within shields 7025A and 7025B, respectively. Referring to the illustrative transmission module 7010A, when the read/write modules 7020A/7015A include light source/photodiode pairs, the shielding 7025A includes a light insulator. When the read/write modules 7020A/7015A include NFC read/write modules, the shielding 7025A includes magnetic/sound shielding. When the read/write modules 7020A/7015A include ultrasound speaker/microphone pairs, the shielding 7025A includes sound shielding.

After reading this disclosure, those skilled in the art will recognize other wired and wireless one-way communication channels in accordance with the invention.

In some embodiments, the HSMs employed in the embodiments described above are configured for Federal Information Processing Standard (FIPS) 140-2, which means that any attempt to steal the signing key from the HSM will be detected and the key will be zeroed out. It will be appreciated that HSMs in accordance with the embodiments can be configured to meet other security standards. Also, in accordance with the embodiments, the encrypted key is behind the cryptographic boundary. Thus, even if the encrypted key is inadvertently stolen, it cannot be used to recover the cleartext key. A hacker cannot recover the key from any other HSMs in the cloud of HSMs (e.g., 1205, FIG. 12), except for the original HSM that exports the key.

In operation of one embodiment, a multi-signed transaction from a user is associated with a key tag, which identifies the user's key for signing the transaction data. The key tag and transaction data are forwarded over a one-way communication channel only during discrete windows in a first sequence of connection windows, such as a pulse train, to a wallet that houses an HSM. Inside the wallet, the key tag is used to determine an encryption of the user's key. The transaction data and encrypted key are both forwarded to the HSM, where the encrypted key is decrypted to determine the cleartext key, the transaction data are signed with the signing (cleartext) key, the cleartext key is deleted, and the signed transaction is transmitted from the HSM, all during any one window within a sequence of processing windows. The signed transaction is pulled from the wallet during a second sequence of connection windows over a second one-way communication channel and later forwarded to a blockchain network. None of the first and second sequence of connection windows and the processing windows overlap. In some embodiments, multiple signatures are needed over a cloud of HSMs before the signed transaction is transmitted over the blockchain network.

Unlike cold wallets on the user/client side, which are slow, error prone, and susceptible to theft of user keys on USB-based devices such as Trevor, embodiments of the invention employ a cold wallet implementation at the server backend. These embodiments ensure that key storage and signing always occur offline. Security is further enhanced by diode paths and other one-way data transmission paths to ensure the mission critical level of security and safety assuming zero trust from the Internet. Because of the nature of this back-end implementation, automation is easy to implement, providing higher performance than prior art systems.

While the examples describe digital wallets storing digital currencies, it will be appreciated that other digital objects can be secured using the principles of the invention.

It will also be appreciated that while the examples describe transmitting transaction data, key tags, encrypted keys, and signed transactions, other data can also be transmitted in accordance with the principles of the invention, such as to provide increased functionality, security, or both, to name only a few examples.

It will also be appreciated that while some embodiments show separate components, components can be integrated. For example, referring to FIG. 18, the read/write module 7020A/7015A can be integrated with the HSM Trusted Client 1270, and the read/write module 7020B/7015B can be integrated with the HSM 1280.

While the examples above describe an iPhone as the smart device from which a user accesses her wallet or other components, it will be appreciated that other smart devices, such as an Android device, can also be used in accordance with the embodiments.

### Web3Fabric—Compliance Details and Zero Knowledge Proofs on a Public Blockchain

Regulators and Financial Institutions/Licensed Parties require knowing and verifying that the necessary compliance has been done on financial transactions. In order to do this verification, traditional finance would have to review PII (personally identifiable information) and review the process and rigor to make sure the proper due diligence was performed. These details previously were siloed internally at all of the different financial institutions/payment companies' internal databases. In any given financial transaction, there are likely many participants facilitating in the execution of completing the transaction, oftentimes with each party having to do the same functional checks as the other licensed parties (often causing duplicative costs). With all of the financial transactions sharded across all the transactions, participants' data infrastructures, transparency on who, when, and how compliance was done on each transaction becomes a herculean task that can only be stitched together by large audits and sometimes a subpoena if needed.

Web3fabric solves for these issues with the following capabilities:

Zero Knowledge proofs are applied to the transaction ID associated with KYC, KYB, PEPs, Sanctions, Age, Transaction Monitoring, and Accreditation in order to show completion on a public searchable block explorer without displaying PII.

Plain text explaining the rigor and date/time of each of the compliance anchors of the above-mentioned items, showing when the verification occurred and the rigor applied.

### Web3fabric—Compliance Details & Zero Knowledge Proofs on a Private Blockchain

In any given transaction there can be multiple licensed parties that are required to perform KYC, PEPs, Sanctions, Transaction Monitoring, and many other activities of manual rigor to make sure that a transaction is compliant. Each of the participating parties will do the identical activities as the others, causing exponential redundancy in costs. This is because the banks have no way to communicate and share this information in a secure manner across multiple parties. For this reason, Simplici has forked Polygon and is creating a private blockchain called Web3fabric. Each Financial Institution Participant will be a node on the private blockchain, thus allowing the PII and all compliance information to be securely shared across the wallets participating in the multisign of the transaction, enabling compliance to be completed once and shared across all licensed participants instantly.

### Multisig Distribution of Private Keys

In some embodiments, implementing a multi-signature (multisig) wallet for Polygon involves using smart contracts on the Polygon network. Multisig wallets add an extra layer of security and require multiple private key signatures to execute transactions, making them a popular choice for managing funds in a decentralized manner. In some embodiments, a 2/2 multisig is used to access control. It will be appreciated that in other embodiments, other ratios of multisig can be used.

In some embodiments, a multisig wallet will be generated using HSMs. In some embodiments, a transaction can be executed by signing it using a secure enclave and then verified using a public key stored in a secure enclave in the server. When new users sign up on the platform, the system will generate a public key and store it in the backend system. The platform will ensure that the public key is encrypted and stored in a vault so that it is secure on the server.

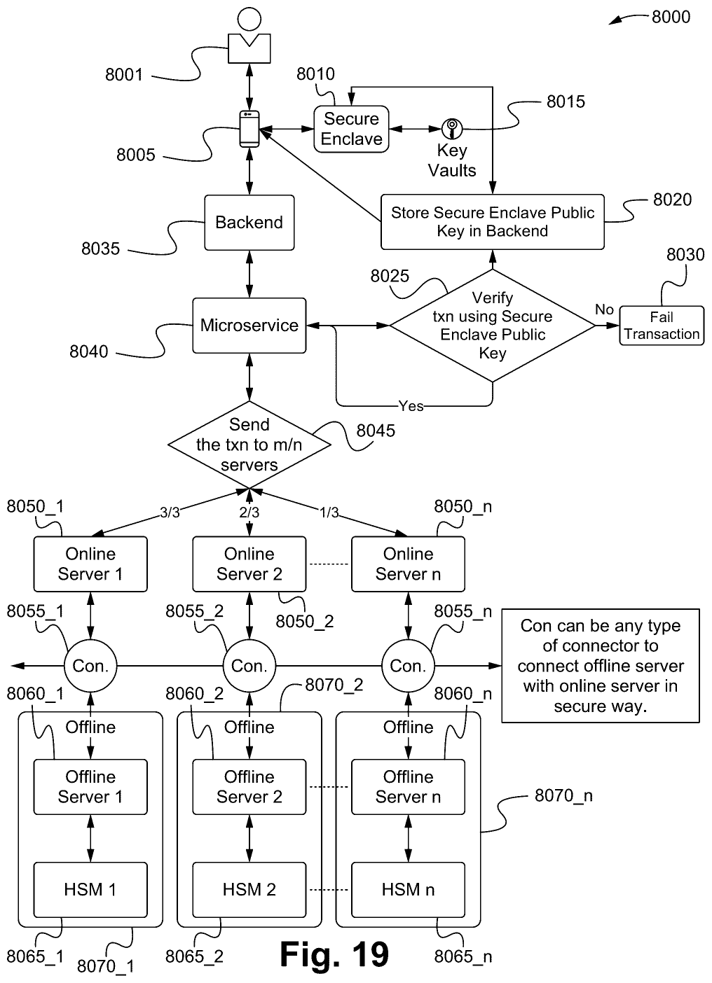

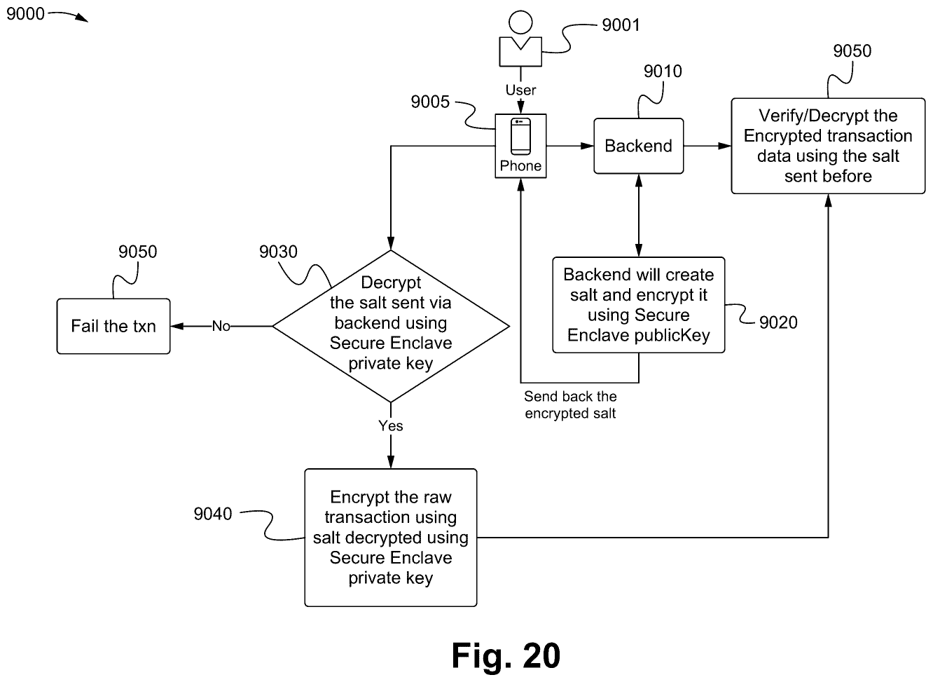

In some embodiments, the platform can require that a minimum number of keys are required to sign and verify the transaction. In some embodiments, all of the private keys are stored in HSM (which serves as a cold wallet and is not exposed to the outside world). In some embodiments, whenever a user initiates the transaction, the platform/system will verify the transaction using the steps of the process 9000 shown in FIG. 20 and then sends the transaction using the air gap to the HSMs 8085_X, X=1 . . . N, as shown in FIG. 19.

### Key Generation

In some embodiments, the key generation will be performed in multisig, and all the keys will be generated using HSM. In some embodiments, this step will be performed during user signup.

### Key Storage

In some embodiments, key storage will be performed in multisig, and all the keys will be stored in the HSMs. In some embodiments, for each user device, one key will be stored in the user's device hardware, which is only accessible to the owner of the device.

### Key Distribution

In some embodiments, key distribution is performed in multisig and all the keys are stored in the HSMs.

### Key Transfer

In some embodiments, keys cannot be transferred.

### Key Usage

In some embodiments, transactions are performed using the HSMs, using the Secure Enclave for verifying that the transaction is valid and sent from the user device.

### Key Backup and Recovery

In some embodiments, the keys stored in the HSMs can be recovered and backed up.

### Key Revocation

In some embodiments, if a key is compromised or the associated account needs to be deactivated, a key revocation process is initiated to invalidate the compromised key, thereby preventing further unauthorized access. In some embodiments, this feature can be implemented because the system stores all the keys.

### Key Destruction

In some embodiments, when a key is no longer needed or has been compromised beyond recovery, the key is securely destroyed to prevent any potential misuse.

### Access Control

In some embodiments, access controls are implemented to ensure that only authorized personnel can manage and access keys throughout the keys' life cycle. Role-based access control and multi-factor authentication are examples of measures that can enhance security.

### Auditing and Monitoring

In some embodiments, processes are implemented to regularly audit and monitor key usage and management to help detect and respond to any suspicious activities or potential security breaches.

In some embodiments the 2/2 multisig keys are stored in HSM. FIG. 19 shows the components and steps of a transaction flow 8000 in accordance with some embodiments. In a first step a user 8001 on a device 8005 retrieves her private key from a secure enclave 8010 through a key vault 8015. The device 8005 also retrieves Secure Enclave Public key for storage in the backend 8035. On the backend 8035, the device 8005 requests a microservice 8040, which, in a step 8025, verifies the transaction using the secure enclave public key. If the transaction is not verified, the process continues to a step 8030, in which the transaction fails. If the transaction is verified, the process returns to the step 8040. From the step 8040, the process continues to a step 8045, in which the transaction is sent to multiple Digital Wallets 8070_1, . . . . 8070_N for signatures. In some embodiments, 3 HSMs are used and a quorum of 2 HSMs (e.g., ⅔ MultiSig) is required for verification. In other embodiments, different numbers of HSMs and different quorums can be used.

In some embodiments, in the step 8045, the transactions are sent to Online Servers 8050_X, for X=1 . . . N, then to a corresponding Connector 8055_X, and from there to a corresponding Digital Wallet 8070_X. Each Digital Wallet 8070_X includes an Offline Server 8060_X and an HSM 8065_X. The Offline Server 8060_X couples each Connector 8055_X to the corresponding HSM 8065_X. Each Connector 8055_X can be any type of connector that couples the Offline Server 8060_X with the Online Server 8050_X in a secure way.

### Transaction Verification Using Secure Enclave

FIG. 20 shows the steps 9000 of a process for verifying a transaction using a secure enclave in accordance with some embodiments. In a step 9005, a user 9001 calls an API on her device 9005 to initiate the transaction. In the step 9010, the API communicates with the backend, which, in a step 9020, creates a salt and encrypts it using Secure Enclave Public Key and transmits the encrypted salt as a response. Once the user receives the encrypted random salt for the transaction, in a step 9030, the user device decrypts the salt sent over the backend server using the secure enclave private key. If the decryption was unsuccessful, the process continues to a step 9035, in which the transaction is indicated as failing. Otherwise, the process continues to a step 9040, in which the raw transaction is encrypted using the salt, which was decrypted using the salt decrypted using the Secure Enclave private key. Next, in a step 9045, the user device sends the encrypted transaction data to the backend. In a step 9050, the backend will decrypt the transaction using the salt created in the step 9020. Next, the transaction is sent to the microservice to be signed by the HSM.

### Quantum of Proof E2E Encryption

Blockchain is a decentralized network secured by a number of cryptographic algorithms. For most chains, the SHA256 is adopted as a proof-of-work to validate the block of transactions. Asymmetric encryption (e.g., Elliptic Curve Digital Signature Algorithm (ECDSA) and Elliptic Curve Cryptography (ECC) are used to sign to authenticate the ownership of funds. Generally, millions of years are required to crack these cryptographic algorithms using all the computing resources on earth. It is anticipated that quantum computing can considerably reduce the cracking time of, if not SHA256, then possibly RSA, ECC, and other algorithms. This is true, in part, because the quantum computing compatible shor's algorithm can degrade the complexity of solving the factoring problem. As a result, hackers may derive the private key no matter how securely it is protected, and they can sign any transaction on a person's behalf using that person's private key.

Thus, in accordance with some embodiments, the private key is stored using FIPS 140-2 level 2 or level 3 certified hardware or software system, such as a hardware security module (HSM), Multiple Party Configuration (MPC), or a mobile phone enclave is used to store and protect the private key or its cryptographic master key, thereby thwarting any attempt to directly steal the key internally or externally.

Also, when quantum computing is developed to a certain level that cracking the private key takes no more than a reasonable duration, e.g., 10 years, the private key should be renewed every half of that period, e.g., every 5 years. The key renewal should happen automatically and controlled using smart contracts or other services/tools. As part of the key renewal, the old wallet should be enforced with a new quorum policy and a smart contract. The old private key controlled wallet should still be monitored because it may still possibly receive deposits. The smart contract will ensure that these deposits must be immediately transferred to the latest wallet. Other than transferring the fund to the latest wallet, the old wallet should not be authorized to transfer money to any other wallets. Multi-signature can be used to ensure that only the quorum of the old wallet+the company owned wallet with biometric authentication combined can sign the transaction to transfer money out of the old wallet. At the new wallet, the customer can use an M over N (M>=2) quorum policy to transfer any funds out of the wallet and to anywhere in their interest.

To hide the above details, a new universal wallet reference ID, e.g. customer email address, can be used to receive all the transaction commands. The company service should be able to find the latest wallet private key for any money transfer requests. By default, the latest wallet key is mapped to this universal wallet ID and all deposits to it should be sent to this latest wallet.

The private key renewal time depends on the quantum computing power. In some embodiments, the renewal time is set to infinite because there is no use case that ECC private keys can be hacked by a quantum computing system. This period may be reduced to arbitrarily shorter times, e.g., 5 years, 3 years, 1 year, 3 months, 1 month, 1 day, etc, depending on the development of quantum computing systems. The company service should be able to store/archive all the past private keys in the record, protected with FIPS 140-2 level 2 or level 3 certified systems, even if these keys are not being actively used. At the user side, users will use their universal wallet ID permanently without worrying about any change in the underlying hardware, systems, and methods.

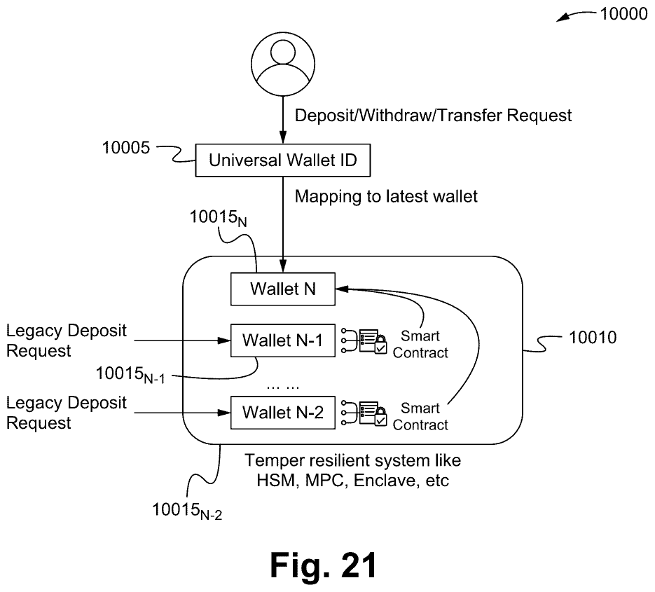

FIG. 21 shows a system 10000 for securing wallets in accordance with some embodiments. The system 10000 maps a User to a Universal Wallet ID 1005. When the User. makes a deposit/withdraw/transfer request, the request is mapped to her Wallet module 10010, containing a current wallet 10015_{N} and multiple legacy wallets 10015_{N-1}, . . . 100015_{N-2} . . . , each mapped to a legacy deposit request. Each of the legacy wallets 10015_{N-1} . . . 10015_{N-2} is coupled to a corresponding smart contract and HSM. In some embodiments, the Wallet module 1010 includes temper resilient systems such as HSM, MPC, Enclave, etc.

While the embodiments describe trading assets on a DeFi network, it will be appreciated that some embodiments of the invention are able to be used to verify users in other blockchain transactions.

Indeed, the details may vary from implementation to implementation according to the requirements of the particular implementation at hand. The example embodiment(s) are, accordingly, to be regarded in an illustrative rather than a restrictive sense.

While the present invention has been described in terms of specific embodiments incorporating details to facilitate the understanding of the principles of construction and operation of the invention, such references herein to specific embodiments and details thereof are not intended to limit the scope of the claims appended hereto. It will be apparent to those skilled in the art that modifications may be made in the embodiments chosen for illustration without departing from the spirit and scope of the invention as defined by the appended claims.

What is claimed is:

1. In a decentralized financing system, a computer-implemented method comprising:
receiving on a smart device a login request from a user for accessing a digital wallet;
verifying an identity of the user on the smart device using a verification sequence;
after verifying the user's identity, retrieving the user's encrypted private key over a cloud network; and
using the retrieved encrypted private key to log on to the user's wallet from the smart device.

2. The system of claim 1, wherein the user's encrypted private key is stored on an iCloud keychain accessible over an iCloud network.

3. The system of claim 2, wherein the user's encrypted private key is indexed by associating the user's account with the iCloud keychain.

4. The system of claim 3, wherein the user's account is associated with the user's account ID.

5. The system of claim 4, wherein the account ID comprises an AppleID or an AndroidID.

6. The system of claim 3, wherein the verification sequence is based on plain text data, Zero-Knowledge Proofs, or both.

7. The system of claim 6, wherein the Zero-Knowledge Proofs are based on one or more of KYC ID, PEPs ID, Sanctions ID, AGE ID, Transaction Monitoring ID, and Accreditation ID.

8. The system of claim 6, wherein the plain text data comprises one or more of a KYC date/time stamp, KYC Rigor, PEPs date/time stamp, a Sanctions date/time stamp, an Accreditation date/time stamp, a Country in which a transaction associated with verification sequence occurs, and a State in which the transaction associated with verification sequence occurs.

9. The system of claim 6, wherein the verification sequence comprises Anti-Money Laundering (AML), Know Your Client (KYC), Know Your Business, any other types of legal compliance requirements, or any combination thereof.

10. The system of claim 9, wherein the verification sequence further comprises one or more biometric similarity tests, one or more liveness tests, or any combination thereof.

11. The system of claim 7, the method further comprising storing in a database or storing encrypted on-chain results of the user's AML and KYC compliance check, indexed by an AML-KYC reference ID, without storing the user's personal identifying information.

12. The system of claim 1, the method further comprising executing a financial transaction on a private blockchain.

13. The system of claim 12, wherein each of the nodes of the private blockchain is associated with a bank, whereby transactions on the nodes are not publicly viewable.

14. The system of claim 1, the system comprising:
the user device;
multiple online servers each coupled to the user device;
multiple digital wallets, each comprising an associated hardware security module (HSM) and offline server pair, each of the HSM offline server pairs coupled to an associated one of the multiple online servers over a corresponding sure connectors, each of the HSMs configured to sign an transaction in a multi-signature system.

15. The system of claim 1, the method further comprising:
signing transaction data within a digital wallet, wherein the digital wallet comprises a hardware security module (HSM) Trusted client coupled to an HSM, wherein the signing comprises:
transmitting transaction data corresponding to a transaction and an encrypted key to an HSM Trusted Client over a first one-way transmission path;
processing the transaction data within the digital wallet comprising:
transmitting the transaction data and the encrypted key from the HSM Trusted Client to the HSM along a two-way transmission path;
inside the HSM, using the encrypted key to recover a signing key and signing the transaction data with the signing key to generate a signed transaction; and
transmitting the signed transaction from the HSM to the HSM Trusted Client along the two-way transmission path; and
transmitting the signed transaction from the HSM Trusted Client over a second one-way transmission path for transmission to a blockchain network,
wherein each transaction data and signed transaction can only be transmitted between the Internet and the digital wallet over the first and second one-way transmission paths, and none of transmitting data along the first one-way transmission path, processing data within the digital wallet, and transmitting data along the second one-way transmission path overlap.

16. In a decentralized financing system, a computer-implemented method for minting an asset comprising:
verifying an identity of a user, using any combination of AML, KYC, and KYB;
storing information relating to the verification of the user, indexed by a reference ID and timestamp;
entering token creation and minting data into a token creation and minting form;
encrypting the token creation and minting data;
storing the encrypted token creation and minting data and asset metadata, wherein the asset metadata includes a symbol name, an image, and a royalties schedule;
updating a token to include token creation and minting data using a smart contract; and
triggering a blockchain transaction;
for every blockchain transaction, replicating token and minting data into a database, and adding onboarding information, excluding personal identifying information, into a memo field; and
in response to a successful transaction, minting the asset on the blockchain.

17. The system of claim 16, the method further comprising transmitting royalty payments to one or more designated parties for each downstream transaction for the asset according to the royalties schedule.

18. The system of claim 16, wherein the token creation and onboarding information are publicly viewable on the blockchain and one or more exchanges.

19. In a decentralized financing system, a computer-implemented method comprising:
receiving on a smart device a login request from a user for accessing a digital wallet;
verifying an identity of the user on the smart device using a verification sequence;
after verifying the user's identity, retrieving the user's encrypted private key over a cloud network; and
using the retrieved encrypted private key to log on to the user's wallet from the smart device, wherein the user's wallet is accessible by unidirectional diodes with non-overlapping access windows.

20. The system of claim 19, wherein the digital wallet comprises an HSM Trusted client coupled to an on-premises HSM storing the user's private key, wherein the HSM Trusted client is communicatively coupled to the on-premises HSM at pre-determined windows.
